(19) United States
(12) Patent Application Publication
(10) Pub. No.: US 2019/0393936 A1
(43) Pub. Date: Dec. 26, 2019

(54) TRANSMISSION APPARATUS, TRANSMISSION METHOD, RECEPTION APPARATUS, AND RECEPTION METHOD

(71) Applicant: Panasonic Intellectual Property Corporation of America, Torrance, CA (US)

(72) Inventors: Hiroyuki MOTOZUKA, Kanagawa (JP); Takenori Sakamoto, Kanagawa (JP); Naganori Shirakata, Kanagawa (JP)

(21) Appl. No.: 16/559,662

(22) Filed: Sep. 4, 2019

Related U.S. Application Data
(63) Continuation of application No. PCT/JP2018/015016, filed on Apr. 10, 2018.
(60) Provisional application No. 62/500,985, filed on May 3, 2017.

(30) Foreign Application Priority Data
Feb. 28, 2018 (JP) 2018-035445

(51) Int. Cl. H04B 7/0456; H04L 27/26

(52) U.S. Cl. CPC H04B 7/0456; H04L 27/2636

(57) ABSTRACT

A transmission apparatus includes a precoder that generates a first precoded signal and a second precoded signal by performing a precoding process on a first baseband signal and a second baseband signal, an order reverser that generates a reversed signal by reversing an order of a symbol sequence forming the second precoded signal, and a transmitter that transmits the first precoded signal and the reversed signal respectively from different antennas such that each signal is transmitted using a single-carrier.

### BACKGROUND

### 1. Technical Field

The present disclosure relates to a transmission apparatus, a transmission method, a reception apparatus, and a reception method, used in communication using a multi-antenna.

### 2. Description of the Related Art

The IEEE802.11ad standard is one of wireless LAN-related standards and is related to wireless communication using a 60 GHz band millimeter wave (IEEE802.11ad™-2012, Dec. 28, 2012). In the IEEE802.11ad standard, transmission using a single-carrier is defined.

As one of communication technologies using multi-antenna, MIMO (Multiple-Input Multiple-Output) is known (“MIMO for DVB-NGH, the next generation mobile TV broadcasting,” IEEE Commun. Mag., vol.57, no.7, pp.130-137, July 2013). Use of MIMO makes it possible to enhance a spatial diversity effect and improve reception quality. Further related information may be found, for example, in IEEE802.11-16/0631r0, May 15, 2016, IEEE802.11-16/0632r0, May 15, 2016, etc.

### SUMMARY

However, in MIMO communication using a single-carrier, there is a possibility that a sufficient frequency diversity effect is not achieved.

One non-limiting and exemplary embodiment of this disclosure provides a technique of enhancing the frequency diversity effect in MIMO communication using a single-carrier in a transmission apparatus, a transmission method, a reception apparatus, and a reception method.

In one general aspect, the techniques disclosed here feature a transmission apparatus including a precoder that generates a first precoded signal and a second precoded signal by performing a precoding process on a first baseband signal and a second baseband signal, an order reverser that generates a reversed signal by reversing an order of a symbol sequence forming the second precoded signal, and a transmitter that transmits the first precoded signal and the reversed signal respectively from different antennas such that each signal is transmitted using a single-carrier.

The one general aspect of the present disclosure makes it possible to enhance the frequency diversity effect in MIMO communication using a single-carrier.

It should be noted that general or specific embodiments may be implemented as a system, a method, an integrated circuit, a computer program, a storage medium, or any selective combination of a system, an apparatus, a method, an integrated circuit, a computer program, and a storage medium.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a configuration of a MIMO communication system according to a first embodiment;

FIG. 2 is a diagram illustrating an example of an amplitude component of a frequency response;

FIG. 3 is a diagram illustrating an example of a configuration of a transmission apparatus according to the first embodiment;

FIG. 4A is a diagram illustrating an example of a constellation for π/2-BPSK for a case where the value of a symbol index is odd;

FIG. 4B is a diagram illustrating an example of a constellation for π/2-BPSK for a case where the value of a symbol index is even;

FIG. 4C is a diagram illustrating an example of a constellation of data output from a precoder;

FIG. 5A is a diagram illustrating an example of a method of adding GI;

FIG. 5B is a diagram illustrating an example of a DFT signal obtained as a result of performing DFT on a symbol block including precoded symbols and an added GI;

FIG. 5C is a diagram illustrating an example of a DFT signal obtained as a result of performing DFT on a symbol block including precoded symbols and an added GI*;

FIG. 6A is a diagram illustrating an example of a symbol order reversion process performed by a symbol order reverser;

FIG. 6B is a diagram illustrating another example of a symbol order reversion process performed by a symbol order reverser;

FIG. 6C is a diagram illustrating an example of a DFT signal obtained as a result of performing DFT on a symbol block including precoded symbols and an added GI;

FIG. 6D is a diagram illustrating an example of a reversed DFT signal obtained as a result of performing DFT on a reversed symbol;

FIG. 6E is a diagram illustrating an example of a DFT signal obtained as a result of performing DFT on phase-shifted symbols on a symbol block-by-symbol block basis;

FIG. 6F is a diagram illustrating an example of a DFT signal obtained as a result of performing DFT on phase-shifted symbols on a symbol block-by-symbol block basis;

FIG. 7 is a diagram illustrating an example of a configuration of a reception apparatus;

FIG. 8 is a diagram illustrating a method of dividing reception data into DFT blocks by a DFT unit;

FIG. 9 is a diagram illustrating an example of a configuration of a transmission apparatus according to a second embodiment;

FIG. 10A is a diagram illustrating an example of a constellation for π/2-QPSK modulation;

FIG. 10B is a diagram illustrating an example of a constellation for 16QAM modulation;

FIG. 11A is a diagram illustrating an example of a DFT signal subjected to a first transmission RF chain process;

FIG. 11B is a diagram illustrating an example of a DFT signal subjected to a second transmission RF chain process;

FIG. 12 is a diagram illustrating an example of a configuration of a transmission apparatus according to a third embodiment;

FIG. 13A is a diagram illustrating an example of symbol sequences output by a precoder;

FIG. 13B is a diagram illustrating frequency-domain signals calculated by performing DFT, in a DFT window, on precoded symbol sequences;

FIG. 14A is a diagram illustrating an example of symbol sequences output by a data symbol buffer and an example of symbol sequences output by a symbol order reverser for the case of a second precoding scheme type;

FIG. 14B is a diagram illustrating frequency-domain signals calculated by performing DFT, in a DFT window, on the symbol sequences shown in FIG. 14A;

FIG. 15A is a flow chart illustrating, in a time domain, a process performed by a complex conjugate calculator and a symbol order reverser on a symbol sequence;

FIG. 15B is a flow chart illustrating, in a frequency domain, a process performed by a complex conjugate calculator and a symbol order reverser on a symbol sequence;

FIG. 16A is a diagram illustrating an example of symbol sequences output by a precoder for the case of a first precoding scheme type;

FIG. 16B is a diagram illustrating frequency-domain signals calculated by performing DFT, in a DFT window, on the symbol sequences shown in FIG. 16A;

FIG. 17 is a diagram illustrating an example of a configuration of a transmission apparatus according to a fourth embodiment;

FIG. 18A is a diagram illustrating an example of a precoding matrix used in one-stream transmission;

FIG. 18B is a diagram illustrating an example of a precoding matrix used in two-stream transmission;

FIG. 19 illustrates an example of a set of constellation points for a case where the modulation scheme is pi/2-(QPSK, 16QAM);

FIG. 20 is a diagram illustrating an example of a configuration of a transmission apparatus according to a modification of the second embodiment;

FIG. 21 is a diagram illustrating an example of a GI addition method according to a modification of the second embodiment;

FIG. 22 is a diagram illustrating another example of a GI addition method according to a modification of the second embodiment;

FIG. 23 is a diagram illustrating an example of a configuration of a transmission apparatus according to a modification of the third embodiment;

FIG. 24 is a diagram illustrating an example of a GI addition method according to a modification of the third embodiment;

FIG. 25 is a diagram illustrating another example of a GI addition method according to a modification of the third embodiment;

FIG. 26 is a diagram illustrating an example of a configuration of a transmission apparatus according to the fourth embodiment; and

FIG. 27 is a diagram illustrating an example of a configuration of a transmission apparatus according to a modification of the third embodiment.

### DETAILED DESCRIPTION

Embodiments of the present disclosure are described in detail below with reference to drawings.

### First Embodiment

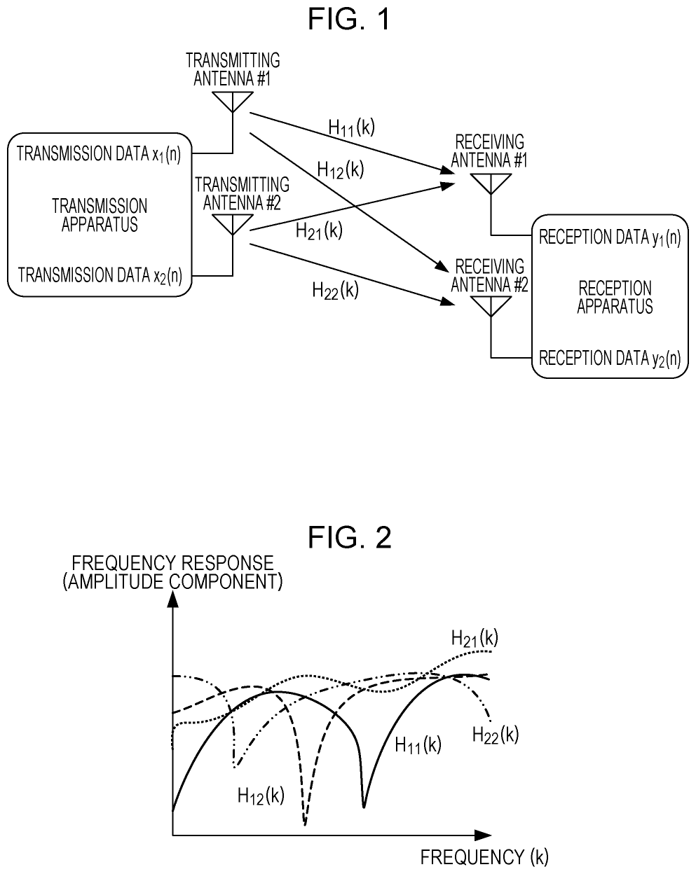

FIG. 1 is a diagram illustrating an example of a configuration of a MIMO communication system. A transmission apparatus includes a plurality of transmitting antennas. A reception apparatus includes a plurality of receiving antennas.

A radio transmission path between one transmitting antenna and one receiving antenna is referred to as a channel. In FIG. 1, a channel H₁₁(k) exists between a first transmitting antenna and a first receiving antenna, a channel H₁₂(k) exists between the first transmitting antenna and a second receiving antenna, a channel H₂₁(k) exists between a second transmitting antenna and the first receiving antenna, and a channel H₂₂(k) exists between the second transmitting antenna and the second receiving antenna. Each channel includes, for example, a direct wave, a reflected wave, a diffracted wave, and/or a scattered wave. Values of channels H₁₁(k), H₁₂(k), H₂₁(k), and H₂₂(k) indicate frequency responses of the respective channels. Each frequency response is represented by a complex number with an index k of frequency.

The transmission apparatus transmits different transmission data from the respective transmitting antennas simultaneously, that is, at the same sampling timing in a D/A converter. The reception apparatus includes a plurality of receiving antennas. The reception apparatus receives reception data via the respective receiving antennas simultaneously, that is, at the same sampling timing in an A/D converter. However, there is a difference in delay among the channels, and thus all pieces of transmission data transmitted simultaneously from the transmission apparatus are not necessarily received at the same time by the reception apparatus.

FIG. 2 is a diagram illustrating an example of an amplitude component distribution of a frequency response. In the example shown in FIG. 2, frequency responses are different among channels, and a correlation among channels is low.

In a case where the reception apparatus receives transmission data x₁(b, n) via the first transmitting antenna, the reception apparatus performs, for example, a process described below. That is, the reception apparatus multiplies the reception data received via the first receiving antenna and the reception data received via the second receiving antenna by respective complex weighting coefficients, and adds results together such that reception signals via the channel H₁₁(k) and the channel H₁₂(k) are intensified while reception signals via the channel H₂₁(k) and the channel H₂₂(k) are suppressed. The weighting coefficients are calculated using, for example, an MMSE (Minimum Mean Square Error) method described later.

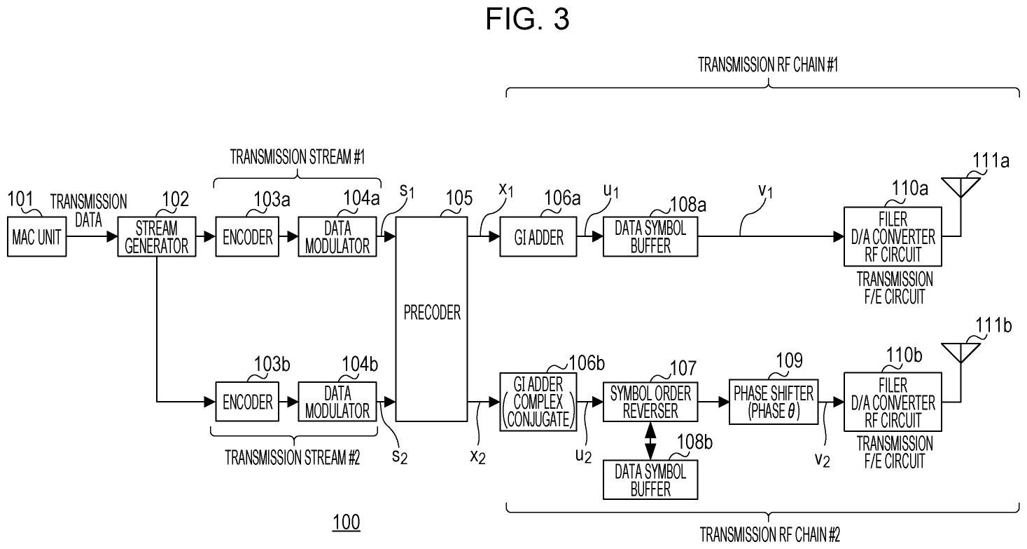

FIG. 3 is a diagram illustrating an example of a configuration of the transmission apparatus 100. In FIG. 3, the transmission apparatus 100 includes a MAC unit (MAC circuit) 101, a stream generator (stream generation circuit) 102, encoders (encoding circuits) 103a and 103b, data modulators (data modulation circuits) 104a and 104b, a precoder (precoding circuit) 105, GI (Guard Interval) adders (GI addition circuits) 106a and 106b, a symbol order reverser (symbol order reversing circuit) 107, data symbol buffers 108a and 108b, a phase shifter (phase shift circuit) 109, transmission F/E circuits (filter, D/A converter, and RF circuit) 110a and 110b, and transmitting antennas 111a and 111b.

The transmission apparatus 100 performs π/2-BPSK modulation by the data modulators 104a and 104b and transmits different data from the respective transmitting antennas 111a and 111b.

The MAC unit 101 generates transmission data and outputs the generated transmission data to the stream generator 102.

The stream generator 102 divides the transmission data into two pieces, that is, first stream data and second stream data. For example, the stream generator 102 assigns odd-numbered bits of the transmission data to the first stream data while the stream generator 102 assigns even-numbered bits of the transmission data to the second stream data. The stream generator 102 outputs the first stream data to the encoder 103a, and outputs the second stream data to the encoder 103b. The stream generator 102 may calculate CRC (Cyclic Redundancy Check) for the transmission data and may add the resultant CRC at the end of the transmission data, and thereafter, the stream generator 102 may generate the stream data.

A process performed on the first stream data output from the stream generator 102 is referred to as a first transmission stream process. The first transmission stream process is performed by the encoder 103a and the data modulator 104a.

A process performed on the second stream data output from the stream generator 102 is referred to as a second transmission stream process. The second transmission stream process is performed by the encoder 103b and the data modulator 104b.

The encoders 103a and 103b perform an error correction coding process on each piece of stream data. The encoders 103a and 103b may employ, for example, LDPC (Low Density Parity Check) coding as the error correction coding scheme.

The data modulators 104a and 104b perform a modulation process on each piece of stream data obtained as a result of the error correction coding process performed by the encoders 103a and 103b. The data modulators 104a and 104b employ, for example, π/2-BPSK as the data modulation scheme.

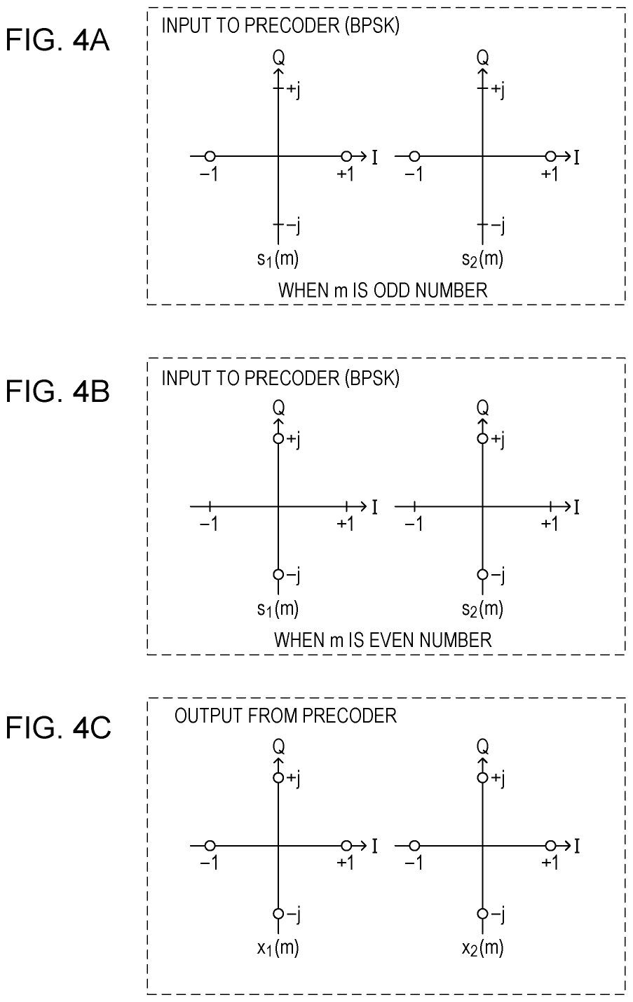

FIG. 4A illustrates an example of a constellation for π/2-BPSK for a case where the value of a symbol index m is odd. FIG. 4B illustrates an example of a constellation of π/2-BPSK for a case where the value of a symbol index m is even. Data (also referred to as a “modulated signal”) output by the data modulator 104a is referred to as a modulated symbol s₁(m), and data output by the data modulator 104b is referred to as a modulated symbol s₂(m) where m is a positive integer representing a symbol index.

In a case where the data modulator 104a performs π/2-BPSK modulation, the modulated symbols s₁(m) and s₂(m) have values described below.
In a case where m is odd, s₁(m) and s₂(m) are placed on an I-axis and take either +1 or −1 as a value.
In a case where m is even, s₁(m) and s₂(m) are placed on a Q-axis and take either +j or −j as a value where j is an imaginary unit.

The precoder 105 multiplies the modulated symbols s₁(m) and s₂(m) output by the data modulators 104a and 104b by a 2-by-2 matrix as shown in equation (1) thereby determining precoded symbols x₁(m) and x₂(m).

$$[ \begin{matrix}{x}_{1} ( m ) \\ {x}_{2} ( m )\end{matrix} ] = \frac{{e}^{- j \frac{π}{4}}}{\sqrt{2}} [ \begin{matrix}1 & j \\ 1 & - j\end{matrix} ] [ \begin{matrix}{s}_{1} ( m ) \\ {s}_{2} ( m )\end{matrix} ] \qquad ( 1 )$$

In equation (1), the 2-by-2 matrix multiplied to s₁(m) and s₂(m) is referred to as a precoding matrix (hereinafter denoted by “G”). That is, the precoding matrix G is represented by equation (2).

$$G = \frac{{e}^{- j \frac{π}{4}}}{\sqrt{2}} [ \begin{matrix}1 & j \\ 1 & - j\end{matrix} ] \qquad ( 2 )$$

Note that the precoding matrix given by equation (2) is merely an example, and another matrix may be employed as the precoding matrix G. For example, another unitary matrix may be employed as the precoding matrix G. Note that the unitary matrix is a matrix satisfying equation (2-1). In equation (2-1), G^{H} denotes a complex conjugate transpose of the matrix G, and I denotes an identity matrix.

G^{H}=GG^{H}=I (2-1)

The precoding matrix G represented by equation (2) satisfies equation (2-1), and thus the precoding matrix G represented by equation (2) is an example of a unitary matrix.

In a case where the precoding matrix G given by equation (2) is used, x₁(m) and x₂(m) satisfy a relationship expressed in equation (2-2) where a symbol * denotes complex conjugate.

x₂(m)=x*₁(m) (2-2)

Another example of a precoding matrix G is shown in equation (2-3).

$$G = \frac{{e}^{- j \frac{π}{4}}}{\sqrt{3}} [ \begin{matrix}1 & j \\ 1 + j & - 1 + j\end{matrix} ] \qquad ( 2 \text{-} 3 )$$

In a case where the precoding matrix G given by equation (2-3) is used, x₁(m) and x₂(m) satisfy a relationship expressed in equation (2-4).

x₂(m)=(1+j)x*₁(m) (2-4)

Another example of a precoding matrix G is shown in equation (2-5). In equation (2-5), a is a constant of a real number, b is a constant of a complex number, and p is a constant indicating an amount of phase shift.

$$G = \frac{{e}^{j ρ}}{\sqrt{( 1 + {\vert a \vert}^{2} ) ( 1 + {\vert b \vert}^{2} ) / 2}} [ \begin{matrix}1 & aj \\ b & - abj\end{matrix} ] \qquad ( 2 \text{-} 5 )$$

In a case where the precoding matrix G given by equation (2-5) is used, x₁(m) and x₂(m) satisfy a relationship expressed in equation (2-6).

x₂(m)=bx*₁(m) (2-6)

In equation (2-5), in a case where a and b are each equal to 1 and ρ is equal to −π/4, equation (2-5) is equal to equation (2).

FIG. 4C is a diagram illustrating an example of a constellation of output data x₁(m) and x₂(m) output by the precoder 105. The constellation shown in FIG. 4C is the same as the constellation in QPSK modulation. That is, the precoder 105 converts two modulated symbol s₁(m) and s₂(m) modulated by the π/2-BPSK into two precoded symbols x₁(m) and x₂(m) corresponding to QPSK symbols according to equation (1).

A process performed on the precoded symbol x₁(m) output from the precoder 105 is referred to as a first transmission RF chain process. The first transmission RF chain process is performed by the GI adder 106a, the data symbol buffer 108a, the transmission F/E (Front End) circuit 110a, and the transmitting antenna 111a.

A process performed on the precoded symbol x₂(m) output from the precoder 105 is referred to as a second transmission RF chain process. The second transmission RF chain process is performed by the complex conjugate GI adder 106b, the symbol order reverser 107, the data symbol buffer 108b, the phase shifter 109, the transmission F/E circuit 110b, and the transmitting antenna 111b.

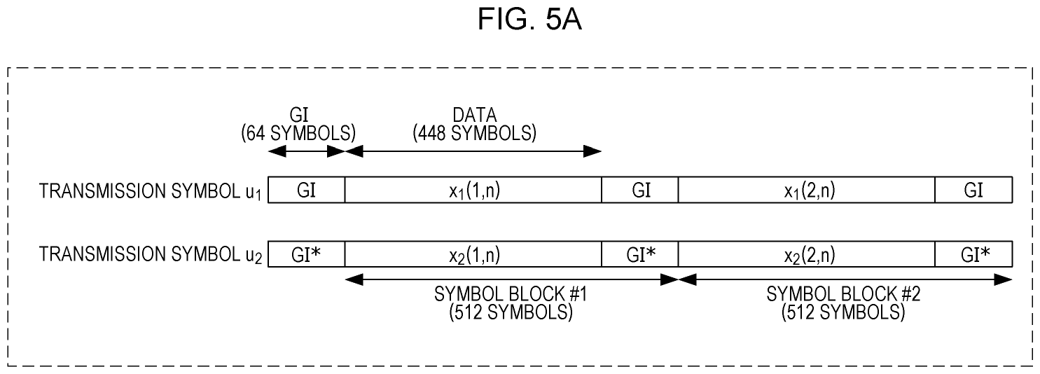

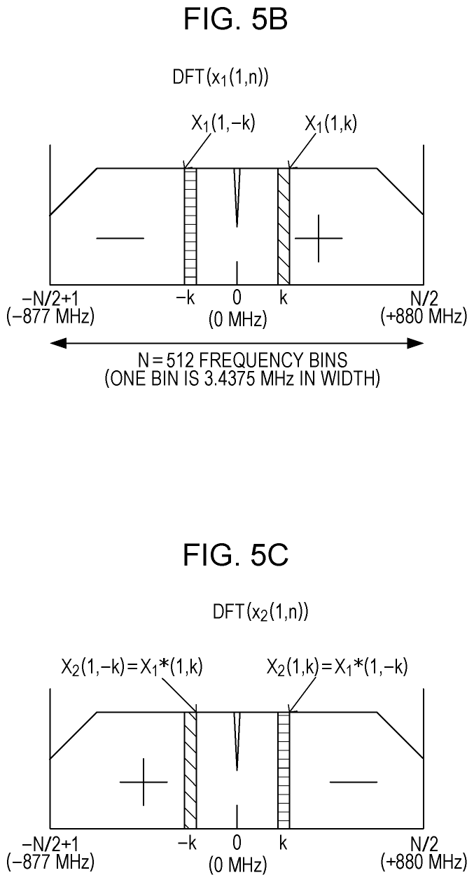

FIG. 5A is a diagram illustrating an example of a method of adding GI by the GI adder 106a and the complex conjugate GI adder 106b.

The GI adder 106a divides the precoded symbol x₁(m) into data blocks each including 448 symbols. For example, first 448 symbols in x₁(m) are put into a first data block (x₁(1, n)), next 448 symbols are put into a second data block (x₁(2, n)), . . . , and b-th 448 symbols are put into a b-th data block (x₁(b, n)). Note that in the present embodiment, n is an integer greater than or equal to 1 and smaller than or equal to 448, and b is a positive integer. That is, x₁(b, n) denotes an n-th precoded symbol in a b-th data block. Note that the numbers of symbols employed above are merely examples, and the numbers of symbols in the present embodiment may be different from these examples.

The GI adder 106a adds a 64-symbol GI in front of each data block. The GI is a symbol sequence obtained as a result of performing π/2-BPSK modulation on a known series. Furthermore, the GI adder 106a adds a 64-symbol GI after a last data block. As a result, a transmission symbol u₁ such as that shown in FIG. 5A is generated.

Similarly, the complex conjugate GI adder 106b divides the precoded symbol x₂(m) into data blocks each including 448 symbols, adds a 64-symbol GI in front of each data block, and adds a 64-symbol GI after a last data block. However, the GIs added by the complex conjugate GI adder 106b are complex conjugates of the GIs added by the GI adder 106a. As a result, a transmission symbol u₂ such as that shown in FIG. 5A is generated.

Here, let GI₁(p) denote a p-th symbol in the GI added by the GI adder 106a, and let GI₂(p) denote a p-th symbol in the GI added by the complex conjugate GI adder 106b. Note that in the present embodiment, p is an integer greater than or equal to 1 and smaller than or equal to 64. In this case, GI₁(p) and GI₂(p) have a relationship described in equation (3), where a symbol * denotes complex conjugate.

GI₂(p)=GI*₁(p) (3)

FIG. 5B illustrates an example of a DFT signal X₁(b, k) obtained as a result of performing a DFT (Discrete Fourier Transform) on a symbol block (refer to the transmission symbol u₁ in FIG. 5A) obtained by adding GI(p) to a precoded symbol x₁(b, n). FIG. 5C illustrates an example of a DFT signal X₂(b, k) obtained as a result of performing a DFT on a symbol block (refer to the transmission symbol u₂ in FIG. 5A) obtained by adding GI*(p) to a precoded symbol x₂(b, n). Next, a frequency characteristic of a signal output by the GI adder 106a is explained below with reference to the DFT signal X₁(b, k). A frequency characteristic of a signal output by the GI adder 106b is also explained below with reference to the DFT signal X₂(b, k).

In the case where the precoding matrix G expressed by equation (2) is used, x₂(b, n) and GI*(p) are respectively complex conjugates of x₁(b, n) and GI(p), and thus the DFT signal X₂(b, k) is a signal obtained by performing frequency inversion on the complex conjugate of the DFT signal X₁(b, k) and further performing phase shifting in frequency domain. That is, X₂(b, k) is represented by equation (3-1).

$${X}_{2} ( b , k ) = {X}_{1}^{*} ( b , - k ) \cdot {e}^{j \frac{2 π k}{N}} \qquad ( 3 \text{-} 1 )$$

Let W denote an amount of phase shift (exp(j×2πk/N)) in equation (3-1) as described below.

$$W = {e}^{j \frac{2 π k}{N}} \qquad ( 3 \text{-} 2 )$$

By performing the precoding process, it is possible to interweave the two modulated symbols s₁(m) and s₂(m) and transmit them using two different transmitting antennas, which makes it possible to achieve a space diversity effect. Furthermore, by performing the precoding process, it is possible to interweave the two modulated symbols s₁(m) and s₂(m) and transmit them using two different frequency indices k and −k, which makes it possible to achieve a frequency diversity effect.

In FIG. 5B and FIG. 5C, in a case where the absolute value|k| of two different frequency indices k and −k is small, the two frequencies are close to each other, and thus a reduction in the frequency diversity effect occurs. An explanation is given below as to a technique of suppressing a reduction in the frequency diversity effect in a situation in which two frequencies are close to each other.

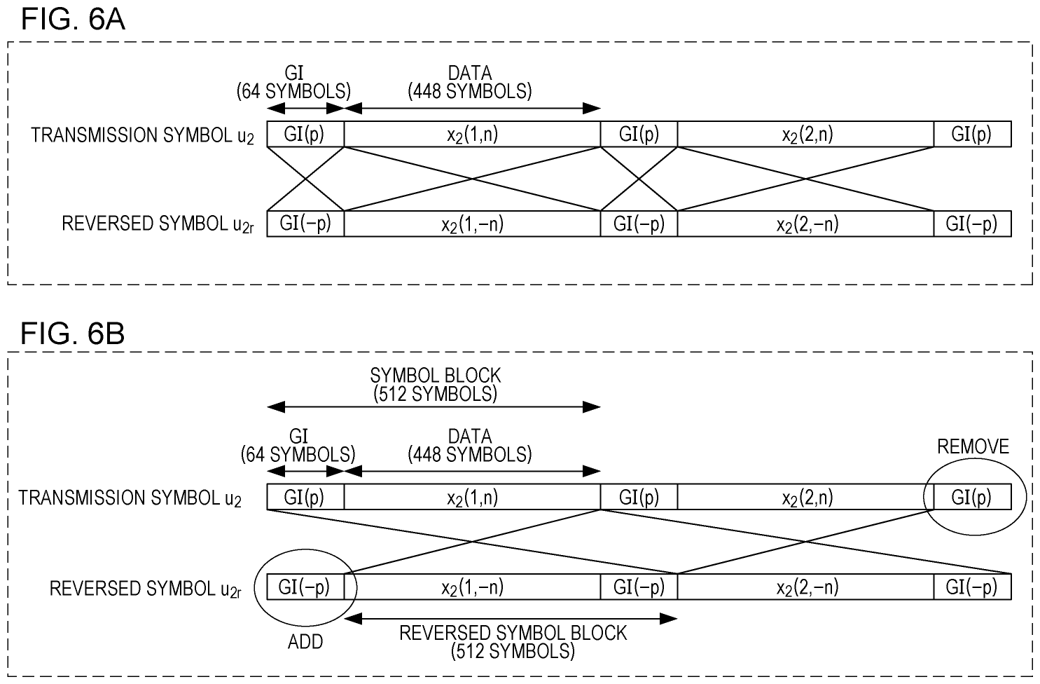

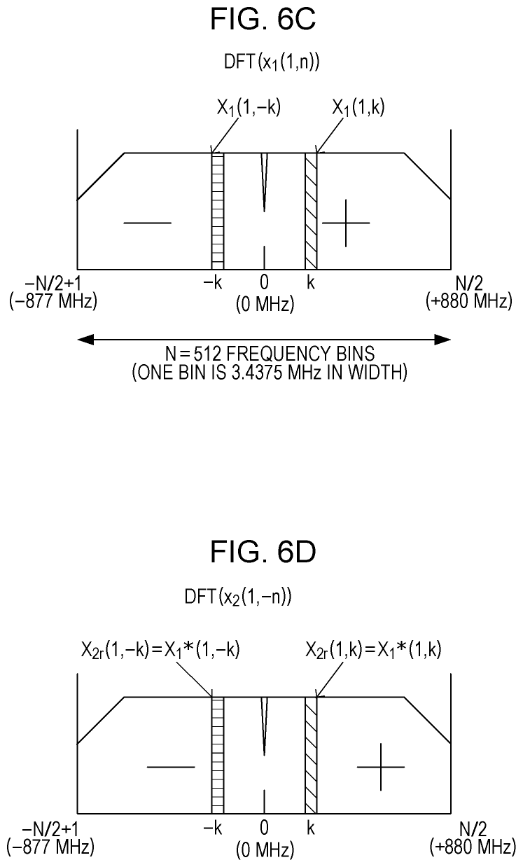

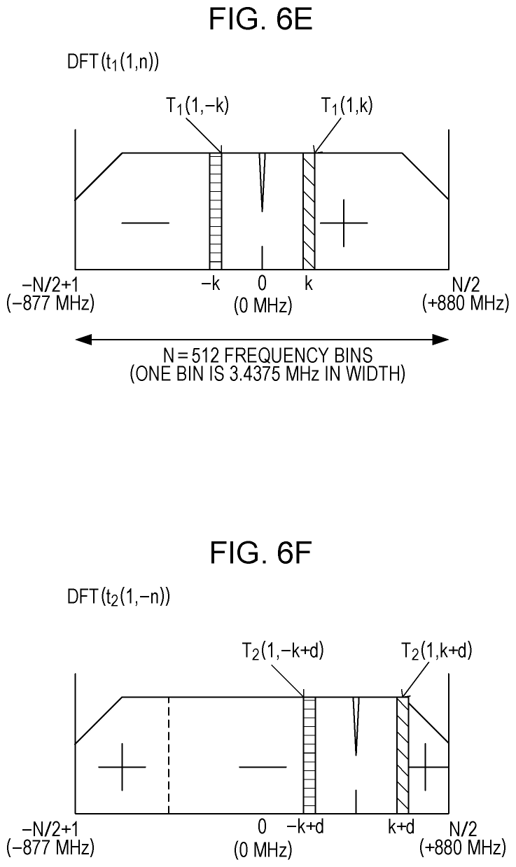

FIG. 6A illustrates an example of a symbol order reversion process performed by the symbol order reverser 107.

As shown in FIG. 6A, the symbol order reverser 107 reverses the order of the precoded symbol x₂(b, n) in each symbol block, and also reverse the order of GI(p) added to the precoded symbol x₂(b, n). For simplicity, the precoded symbol x₂^{(time reversal)}(b, n) obtained as a result of reversing the order is represented by equation (4). That is, the symbol sequence reversed in order is denoted by −n.

x₂^{(time reversal)}(b,n)=x₂(b,−n)=x₂(b,448−n+1) (4)

On the other hand, GI₂^{(time reversal)}(p) reversed in order is represented by equation (5). That is, the symbol sequence reversed in order is denoted by −p.

GI₂^{(time reversal)}(p)=GI₂(−p)=GI₂(64−p+1) (5)

FIG. 6C illustrates an example of a DFT signal X₁(b, k) obtained as a result of performing DFT on a symbol block (refer to the transmission symbol u₁ in FIG. 5A) obtained by adding GI(p) to the precoded symbol x₁(b, n). FIG. 6C is similar to FIG. 5B. FIG. 6D illustrates an example of a reversed DFT signal X₂ᵣ(b, k) obtained as a result of performing DFT on a reversed symbol x₂(−m). Herein, the reversed symbol x₂(−m) includes a precoded symbol signal x₂(b, −n) obtained as a result of performing symbol order reversion and GI*(−p) obtained as a result of performing symbol order reversion on the complex conjugate of GI. Next, a frequency characteristic of a signal output by the symbol order reverser 107 is explained below with reference to the reversed DFT signal X₂ᵣ(b, k).

In the case where the precoding matrix G expressed by equation (2) is used, x₂(b, −n) and GI*(−p) are respectively complex conjugates of symbol blocks obtained as a result of performing the order reversion on x₁(b, n) and GI(p), and thus X₂ᵣ(b, k) is represented by equation (5-2).

X₂ᵣ(b, k)=X*₁(b, k)·W (5-2)

The reversed DFT signal X₂ᵣ(b, k) is a signal obtained as a result of applying a phase shift to the complex conjugate of the DFT signal X₁(b, k). Note that in equation (5-2), N included in W represents a DFT size (for example, a length “512” of a symbol block).

In the examples shown in FIG. 6C and FIG. 6D, unlike the examples shown in FIG. 5B and FIG. 5C, the DFT signal X₁(b, k) subjected to the first transmission RF chain process and the reversed DFT signal X₂ᵣ(b, k)=X*₁(b, k)×W subjected to the second transmission RF chain process are transmitted with the same frequency index k, which makes it possible to achieve a space diversity effect.

FIG. 6B illustrates another example of a symbol order reversion process performed by the symbol order reverser 107.

As shown in FIG. 6B, the symbol order reverser 107 reverses the order of a symbol sequence (a series of symbols) in each whole symbol block. In this process, to put GI in the symbol block such the location of the GI is the same before and after the symbol order reversion is performed, the symbol order reverser 107 may remove GI added at the location after the last data block and may add a symbol-order-reversed GI in front of the first data block. Note that the symbol block is, for example, as described above, a 512-symbol block obtained by combining a 64-symbol GI and a 448-symbol data block.

The symbol order reverser 107 may sequentially store data symbols in the transmission symbol u₂ output by the complex conjugate GI adder 106b in the data symbol buffer 108b such that 448 symbols are stored at a time, and may read data symbols in an order different from (in an order opposite to) the order in which data symbols are stored in the data symbol buffer 108b thereby reversing the order of symbols. That is, the data symbol buffer 108b may be of a type of a LIFO (Last In, First Out) buffer. The data symbol buffer 108b may be a memory, a RAM, a register, or the like.

The process performed by the symbol order reverser 107 to reverse the symbol order of the transmission symbol u₂ causes output data to have a delay with respect to input data. To handle the above situation, using the data symbol buffer 108a, a delay with a length equal to the delay that occurs in the symbol order reverser 107 is given to a data symbol (for example, x₂(b, n)) in the transmission symbol u₂ output by the GI adder 106a. As a result, the transmission symbol u₁ output by the GI adder 106a and the transmission symbol u₂ output by the complex conjugate GI adder 106b are transmitted at the same timing. Note that in the following description, a symbol block obtained by reversing the transmission symbol u₂ by the symbol order reverser 107 is also referred to as a reversed symbol u₂ᵣ.

The phase shifter 109 gives a different phase shift to each data symbol (for example, x₂(b, n)) in the reversed symbols u₂ᵣ output by the symbol order reverser 107. That is, the phase shifter 109 changes phases of symbols by different amounts depending on the symbols. The phase shifter 109 gives a phase shift to a data symbol (for example, x₂(b, n)) according to equation (6), and gives a phase shift to GI (for example, GI₂(p)) according to equation (7). Note that in equation (6) and equation (7), θ denotes the amount of phase shift.

t₂(b, n)=e^{jθn}x₂(b, −n) (6)

GI₂(p)=e^{jθp}GI₂(−p) (7)

The transmission apparatus 100 does not give a phase shift to x₁(b, n) in transmission symbols output by the precoder 105 but gives a phase shift to x₂(b, n) in the transmission symbols output by the precoder 105. The transmission symbol obtained as a result of the phase shift is represented by equation (8).

$$[ \begin{matrix}{t}_{1} ( b , n ) \\ {t}_{2} ( b , n )\end{matrix} ] = [ \begin{matrix}1 & 0 \\ 0 & {e}^{j θ n}\end{matrix} ] [ \begin{matrix}{x}_{1} ( b , n ) \\ {x}_{2} ( b , - n )\end{matrix} ] \qquad ( 8 )$$

Although in FIG. 3, the phase shifter 109 is provided in the second transmission RF chain process, a phase shifter may be provided in both the first transmission RF chain process and the second transmission RF chain process. In a case where this configuration is employed, a phase shift matrix shown in equation (9) may be used.

$$P = [ \begin{matrix}1 & 0 \\ 0 & {e}^{j θ n}\end{matrix} ] \qquad ( 9 )$$

Note that in a case where n in equation (8) is greater than or equal to 1 and smaller than or equal to 448, this equation may be regarded as an equation in terms of a data symbol (for example equation (6)), while in a case where n is greater than or equal to 449 and smaller than or equal to 512, the equation may be regarded as an equation in terms of GI (for example, equation (7) for a case where p is given by a value obtained as a result of subtracting 448 from n in equation (8)). In this case, in equation (8), n is greater than or equal to 1 and smaller than or equal to 512, and x₁(b, n) and x₂(b, −n) include both a data symbol and GI.

FIG. 6E is a diagram illustrating a DFT signal T₁(b, k) obtained by performing DFT on the phase-shifted symbol t₁(b, n) on a symbol block-by-symbol block basis. FIG. 6F is a diagram illustrating a DFT signal T₂(b, k) obtained by performing DFT on the phase-shifted symbol t₂(b, n) on a symbol block-by-symbol block basis. Next, a frequency characteristic of a phase-shifted signal is explained below with reference to T₁(b, k) and T₂(b, k).

Equation (8) indicates that X₁(b, k) and T₁(b, k) are equal to each other. That is, FIG. 6C and FIG. 6E are the same except that symbol X₁ is replaced by symbol T₁.

T₂(b, k) shown in FIG. 6F is a signal obtained by giving a phase shift in time domain to X₂ᵣ(b, k). When a phase shift is given in time domain according to equation (8), the frequency index is shifted in frequency domain by an amount corresponding to a frequency bin d calculated according to equation (9-1). N is a DFT size (for example, a length of a symbol block equal to 512).

d=Nθ/2π (9-1)

Thus, X₁(b, k) is transmitted as T₁(b, k) and T₂(b, k+d) according to equation (9-2) using two transmitting antennas and two frequency indices k and k+d. Thus, a space diversity effect and a frequency diversity effect are obtained.

$$\{ \begin{matrix}{T}_{1} ( b , k ) = {X}_{1} ( b , k ) \\ {T}_{2} ( b , k + d ) = {X}_{2 r} ( b , k ) = {X}_{1}^{*} ( b , k ) \cdot W\end{matrix} \qquad ( 9 \text{-} 2 )$$

The transmission apparatus 100 is capable of enhancing the frequency diversity effect and the data throughput by setting the amount of phase shift θ to a value close to π radian (180°) or −π radian (−180°).

Note that the transmission apparatus 100 may set the amount of phase shift θ to a value different from π radian (180°). This makes it possible to easily achieve a signal separation between the transmission signal associated with the transmitting antenna 111a and the transmission signal associated with the transmitting antenna 111b. Furthermore, it is also possible to increase the data throughput.

A method of giving a phase shift other than π radian to a transmission symbol in OFDM is disclosed, as a PH (Phase Hopping) technique, in “MIMO for DVB-NGH, the next generation mobile TV broadcasting,” IEEE Commun. Mag., vol. 57, no. 7, pp. 130-137, July 2013. However, in the transmission apparatus 100 according to the present disclosure, unlike the case of “MIMO for DVB-NGH, the next generation mobile TV broadcasting,” IEEE Commun. Mag., vol. 57, no. 7, pp. 130-137, July 2013, single-carrier transmission is used, and symbol order reversion is performed in the second transmission stream process. This makes it possible to easily separate two transmission signals from each other. Furthermore, a relatively high frequency diversity effect is achieved.

The transmission apparatus 100 may set the amount of phase shift θ to a value such as −7π/8 radian (d is −224), −15π/16 radian (d is 240), or the like.

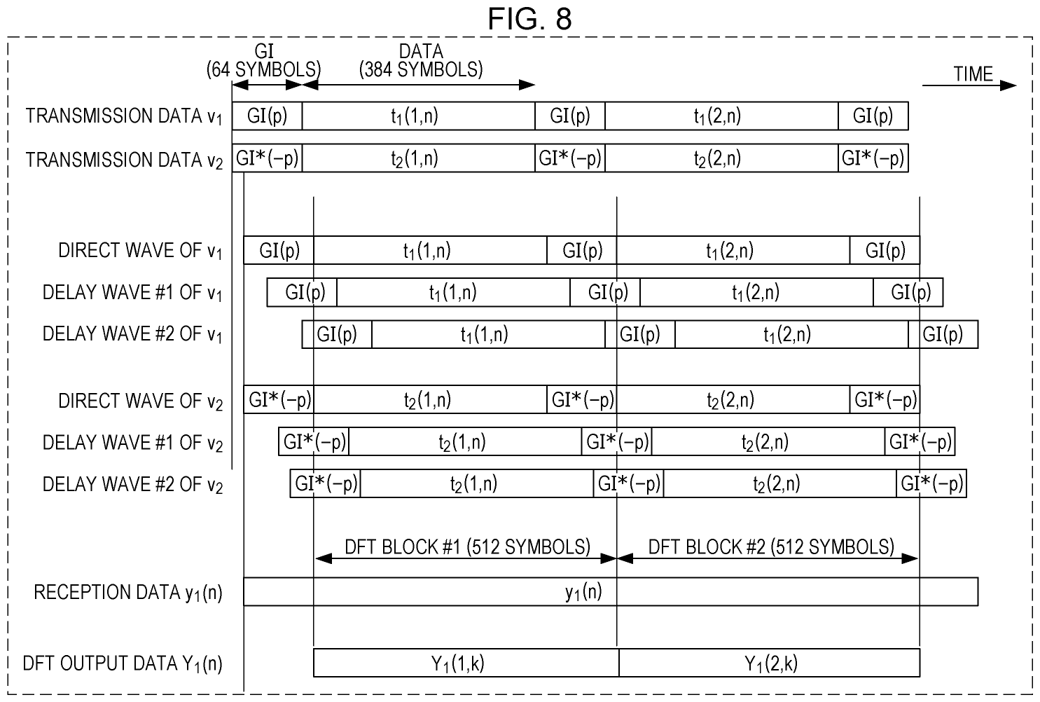

The transmission F/E circuits 110a and 110b each include digital and analog filters, a D/A converter, and an RF (radio) circuit. The transmission F/E circuit 110a converts transmission data v₁ (a signal including GI(p) and t₁(b, n) shown in FIG. 8) output from the data symbol buffer 108a to a radio signal, and outputs the resultant radio signal to the transmitting antenna 111a. The transmission F/E circuit 110b converts transmission data v₂ (a signal including GI*(−p) and t₂(b, −n) shown in FIG. 8) output from the phase shifter 109 to a radio signal, and outputs the resultant radio signal to the transmitting antenna 111b.

The transmitting antenna 111a transmits the radio signal output from the transmission F/E circuit 110a. The transmitting antenna 111b transmits the radio signal output from the transmission F/E circuit 110b. That is, the transmitting antennas 111a and 111b respectively transmit different radio signals.

As described above, the transmission apparatus 100 performs the precoding on two pieces of transmission stream data and then performs the symbol order reversion and the phase shift on one of the two pieces of transmission stream data. This makes it possible to enhance the space diversity effect and the frequency diversity effect. Furthermore, it is also possible to reduce the error rate in data communication and enhance the data throughput.

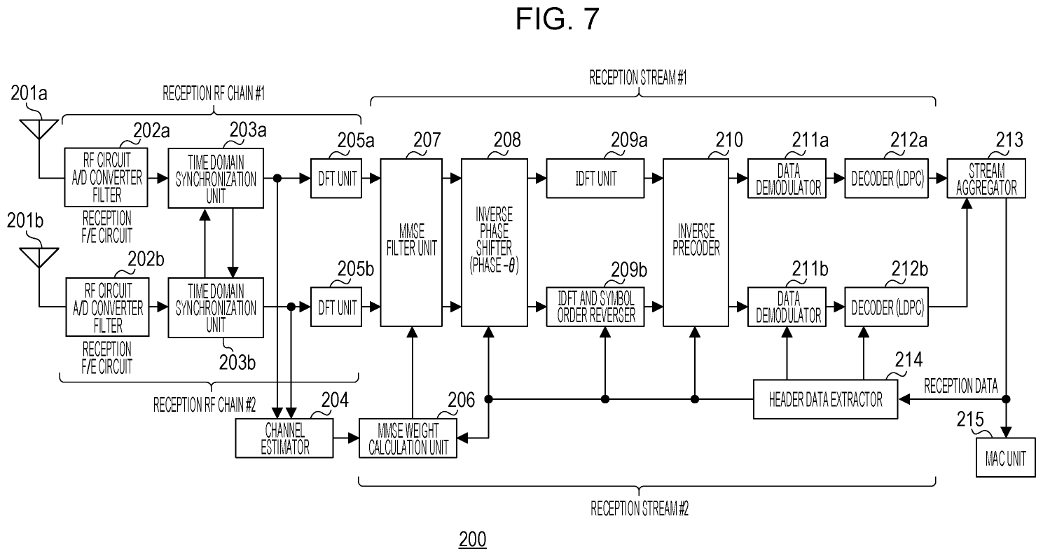

FIG. 7 is a diagram illustrating a configuration of a reception apparatus 200.

Receiving antennas 201a and 201b respectively receive radio signals. A process performed on a reception signal received by the receiving antenna 201a is referred to as a first reception RF chain process. The first reception RF chain process is performed by a reception F/E circuit 202a, a time domain synchronization unit 203a, and a DFT unit 205a. A process performed on a reception signal received by the receiving antenna 201b is referred to as a second reception RF chain process. The second reception RF chain process is performed by a reception F/E circuit 202b, the time domain synchronization unit 203b, and a DFT unit 205b.

The reception F/E circuits 202a and 202b include, for example, an RF circuit, an A/D converter, a digital filter, an analog filter, and a down sampling unit, and the reception F/E circuits 202a and 202b convert radio signals into digital baseband signals.

The time domain synchronization units 203a and 203b perform control to achieve timing synchronization of reception packets. Note that the time domain synchronization unit 203a and the time domain synchronization unit 203b may exchange timing information with each other and may achieve timing synchronization between the first reception RF chain process and the second reception RF chain process.

A channel estimator (channel estimation circuit) 204 calculates a frequency response of a radio channel between the transmission apparatus and the reception apparatus using the reception signal associated with the first reception RF chain process and the reception signal associated with the second reception RF chain process. That is, H₁₁(k), H₁₂(k), H₂₁(k), and H₂₂(k) in FIG. 1 are calculated for each frequency index k.

The DFT units 205a and 205b divide the reception data into DFT blocks and perform DFT. Each DFT block includes, for example, 512 symbols. FIG. 8 is a diagram illustrating a method of dividing reception data into DFT blocks by the DFT units 205a and 205b.

Let y₁(n) denote reception data subjected to the first reception RF chain process (input data applied to the DFT unit 205a), and let y₂(n) denote reception data subjected to the second reception RF chain process (input data applied to the DFT unit 205b). Next, referring to FIG. 8, a process performed on y₁(n) is explained. Note that a process performed on y₂(n) is similar to that performed on y₁(n).

As described above, the transmission apparatus 100 transmits two radio signals (transmission data v₁ and transmission data v₂ shown in FIG. 8) using the two transmitting antennas 111a and 111b. Note that there is a possibility that the two radio signals each create, in a channel, a direct wave and a plurality of delay waves, which arrive at the receiving antennas 201a and 201b.

Note that the reception signals each may include, for example, a diffracted wave and a scattered wave in addition to the direct wave and the delay waves.

The DFT unit 205a determines a first DFT block time so as to include a direct wave and a delay wave of a data block t₁(1, n) of transmission data v₁ and data block t₂(1, n) of a transmission data v₂. A result of DFT calculation of the first DFT block is denoted as Y₁(1, k), where k indicates, as described above, a frequency index and is given by an integer, for example, greater than or equal to 1 and smaller than or equal to 512.

Similarly, results of DFT calculations of a b-th DFT block by the DFT units 205a and 205b are respectively denoted as Y₁(b, k) and Y₂(b, k) (b is an integer greater than 1).

The reception apparatus 200 calculates estimated values of the transmitted modulated symbols s₁(n) and s₂(n) using an MMSE weight calculation unit (MMSE weight calculation circuit) 206, an MMSE filter (MMSE filter circuit) 207, an inverse phase shifter (inverse phase shifting circuit) 208, an IDFT (inverse DFT) unit (IDFT circuit) 209a, an IDFT and symbol order reverser (IDFT and symbol order reversing circuit) 209b, and an inverse precoder (inverse precoding circuit) 210. Next, a method of calculating estimated values of transmitted modulated symbols s₁(n) and s₂(n) is explained.

The output signals Y₁(b, k) and Y₂(b, k) output from the DFT units 205a and 205b in the reception apparatus 200 are represented using channel values as expressed in equation (10).

$$\{ \begin{matrix}{Y}_{1} ( b , k ) = {H}_{11} ( k ) {T}_{1} ( b , k ) + {H}_{12} ( k ) {T}_{2} ( b , k ) + {Z}_{1} ( b , k ) \\ {Y}_{2} ( b , k ) = {H}_{21} ( k ) {T}_{1} ( b , k ) + {H}_{22} ( k ) {T}_{2} ( b , k ) + {Z}_{2} ( b , k )\end{matrix} \qquad ( 10 )$$

In equation (10), T₁(b, k) is a signal obtained as a result of performing DFT on a symbol block (t₁(b, n) in equation (8)) in the transmission apparatus 100. T₂(b, k) is a signal obtained as a result of performing DFT on a symbol block (t₂(b, n) in equation (8)) in the transmission apparatus 100. Z₁(b, k) is a signal obtained as a result of performing DFT on noise in the first RF chain unit. Z₂(b, k) is a signal obtained as a result of performing DFT on noise in the second RF chain unit.

Equation (10) can be expressed using matrices as in equation (11).

$$[ \begin{matrix}{Y}_{1} ( b , k ) \\ {Y}_{2} ( b , k )\end{matrix} ] = {H}_{2 \times 2} ( k ) [ \begin{matrix}{T}_{1} ( b , k ) \\ {T}_{2} ( b , k )\end{matrix} ] + [ \begin{matrix}{Z}_{1} ( b , k ) \\ {Z}_{2} ( b , k )\end{matrix} ] \qquad ( 11 )$$

In equation (11), a channel matrix H_{2×2}(k) is determined as shown in equation (12).

$${H}_{2 \times 2} ( k ) = [ \begin{matrix}{H}_{11} ( k ) & {H}_{12} ( k ) \\ {H}_{21} ( k ) & {H}_{22} ( k )\end{matrix} ] \qquad ( 12 )$$

The MMSE weight calculation unit 206 calculates a weight matrix W_{2×2}(k) according to equation (12-1).

W_{2×2}(k)=H_{2×2}^{H}(k)(H_{2×2}(k)H_{2×2}^{H}(k)+σ²I_{2×2})⁻¹ (12-1)

In equation (12-1), H_{H} denotes a complex conjugate transpose of a matrix H, σ₂ is the variance of noise Z₁(b, k) and noise Z₂(b, k), and I_{2×2} is a 2-by-2 identity matrix.

The MMSE filter 207 calculates estimated values T\hat{ }₁(b, k) and T\hat{ }₂(b, k) of T₁(b, k) and T₂(b, k) according to equation (12-2). Note that a process associated with the estimated value T\hat{ }₁(b, k) is referred to as a first reception stream process, and a process associated with the estimated value T\hat{ }₂(b, k) is referred to as a second reception stream process.

$$[ \begin{matrix}{\hat{T}}_{1} ( b , k ) \\ {\hat{T}}_{2} ( b , k )\end{matrix} ] = {W}_{2 \times 2} ( k ) [ \begin{matrix}{Y}_{1} ( b , k ) \\ {Y}_{2} ( b , k )\end{matrix} ] \qquad ( 12 \text{-} 2 )$$

The calculation according to equation (12-2) is referred to as an MMSE algorithm. The MMSE filter 207 acquires estimated values of phase-shifted data symbols t₁(b, n) and t₂(b, n) based on the MMSE algorithm from t₁(b, n) included in the transmission data v₁, t₂(b, n) included in the transmission data v₂, and reception data y₁ and y₂ including a mixture of direct waves and delay waves (see FIG. 8). In order to make it possible to easily perform the calculation, the MMSE filter 207 performs the calculation on the frequency-domain signal as shown in equation (12-2) using estimated channel values (estimated values of channel frequency response) H₁₁(k), H₁₂(k), H₂₁(k), and H₂₂(k).

The inverse phase shifter 208 performs a process inverse to the process performed by the phase shifter 109 shown in FIG. 3. In the process performed by the phase shifter 109, in frequency domain, the frequency indices k and −k are shifted by amounts corresponding to a frequency bin d as shown in FIG. 6F where d is calculated according to equation (9-1). Therefore, the inverse phase shifter 208 shifts a frequency-domain signal of the second reception stream output from the MMSE filter 207 by an amount corresponding to −d. That is, the inverse phase shifter 208 performs a process in frequency domain according to equation (12-3).

$$\{ \begin{matrix}{\hat{X}}_{1} ( b , k ) = {\hat{T}}_{1} ( b , k ) \\ {\hat{X}}_{2} ( b , k - d ) = {\hat{T}}_{2} ( b , k )\end{matrix} \qquad ( 12 \text{-} 3 )$$

Note that in the reception apparatus 200, the IDFT unit 209a and the IDFT and symbol order reverser 209b may be exchanged with the inverse phase shifter 208, and an inverse phase shift may be applied after IDFT is performed on the output from the MMSE filter. In this case, the inverse phase shifter 208 performs a process in time domain according to equation (12-4).

$$[ \begin{matrix}{\hat{x}}_{1} ( b , n ) \\ {\hat{x}}_{2} ( b , n )\end{matrix} ] = [ \begin{matrix}1 & 0 \\ 0 & {e}^{- j θ n}\end{matrix} ] [ \begin{matrix}{\hat{t}}_{1} ( b , n ) \\ {\hat{t}}_{2} ( b , - n )\end{matrix} ] \qquad ( 12 \text{-} 4 )$$

That is, when the inverse phase shifter 208 gives an inverse phase shift to the second reception stream data, the inverse phase shifter 208 performs a process that is the same as the multiplication given by the matrix P defined by equation (9) because the symbol order is reversed by the IDFT and symbol order reverser 209b.

The IDFT unit 209a performs IDFT on the first reception stream data output from the inverse phase shifter 208. The IDFT and symbol order reverser 209b performs IDFT on the second reception stream data output from the inverse phase shifter 208 and reverses a symbol order of each DFT block.

The inverse precoder 210 multiplies an inverse matrix of the precoding matrix G used by the precoder 105 shown in FIG. 3 to the first reception stream data and the second reception stream data thereby calculating estimated values of s₁(b, n) and s₂(b, n). Equation (12-5) indicates the process performed by the inverse precoder 210.

$$[ \begin{matrix}{\hat{s}}_{1} ( b , n ) \\ {s}_{2} ( b , n )\end{matrix} ] = {G}^{- 1} [ \begin{matrix}{\hat{x}}_{1} ( b , n ) \\ {\hat{x}}_{2} ( b , n )\end{matrix} ] \qquad ( 12 \text{-} 5 )$$

Data demodulators 211a and 211b demodulate data of the estimated values of s₁(b, n) and s₂(b, n) output from the inverse precoder 210 thereby determining the estimated values in the form of bit data.

Decoders 212a and 212b perform an LDPC error correction process on the estimated values in the form of bit data.

A stream aggregator 213 aggregates the first reception stream data and the second reception stream data and transmits a result as reception data to a MAC unit 215.

A header data extractor 214 extracts header data from the reception data, and determines, for example, MCS (Modulation and Coding Scheme) and the amount of phase shift θ used by the phase shifter 109 shown in FIG. 3. The header data extractor 214 may make control as to the precoding matrix G applied to the inverse precoder 210, as to whether the symbol reversion process is to be performed in the IDFT and the symbol order reverser 209b, and as to the amount of phase shift θ used by the inverse phase shifter 208.

In the reception apparatus 200, the MMSE filter 207 performs the estimation using the transmission signals T₁(b, k) and T₂(b, k) obtained as a result of performing frequency shift on the second transmission stream data, and thus it is possible to achieve a further greater frequency diversity effect. Furthermore, it is possible to achieve a reduction in reception error rate and an increase in data throughput.

### Effects of First Embodiment

In the first embodiment described above, the transmission apparatus 100 processes the second precoded symbol such that the complex conjugate of GI added to the first precoded symbol is added, the symbol order is reversed, and the phase shift (phase changing) is given.

Thus, it is possible to achieve a great frequency diversity effect in MIMO channel. It is also possible to reduce the communication data error rate and improve the data throughput.

### Second Embodiment

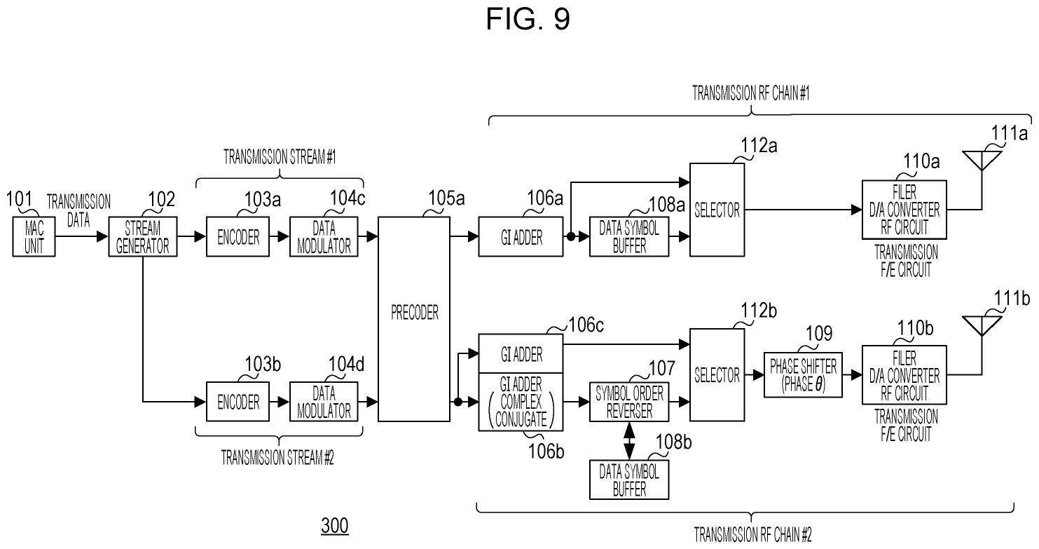

In the first embodiment described above, the transmission apparatus 100 performs MIMO transmission by performing π/2-BPSK modulation using the data modulators 104a and 104b. In a second embodiment described below, a transmission apparatus 300 (see FIG. 9) performs MIMO transmission using data modulators 104a and 104b such that a plurality of data modulation schemes (for example, π/2-BPSK modulation and π/2-QPSK modulation) are switched.

FIG. 9 is a diagram illustrating an example of a configuration of the transmission apparatus 300 according to the second embodiment. Note that same constituent elements as those in FIG. 3 are denoted by same reference numerals, and a further description thereof is omitted.

Data modulators 104c and 104d perform data modulation on encoded data output by encoders 103a and 103b under the control of a MAC unit 101.

Next, an explanation is given below as to an example in which a precoding process performed by the precoder 105a is switched depending on whether π/2-BPSK modulation or π/2-QPSK modulation is employed.

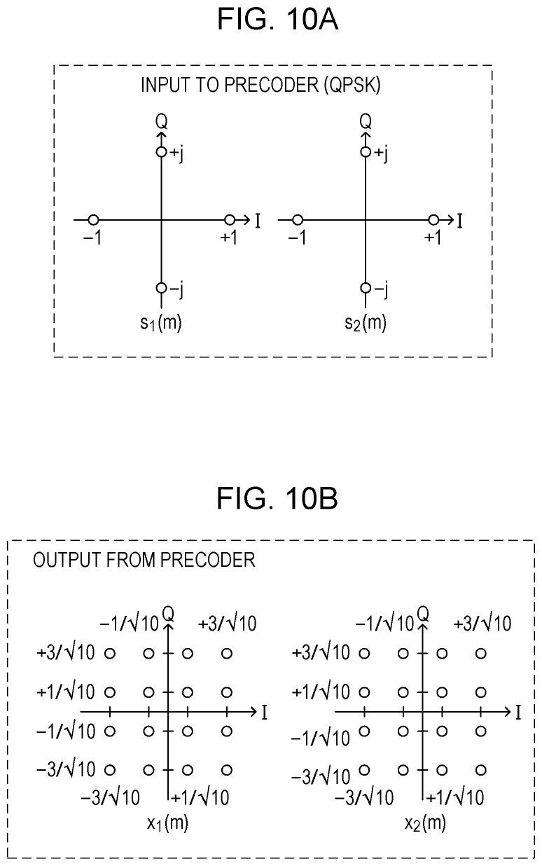

FIG. 10A is a diagram illustrating an example of a constellation for π/2-QPSK modulation. Modulated symbols s₁(m) and s₂(m) output from the data modulators 104c and 104d each take one of values +1, −1, +j, and −j. Note that a constellation for π/2-BPSK modulation is as shown in FIG. 4A.

The precoder 105a changes a precoding matrix depending on a data modulation scheme used by the data modulator 104c or 104d thereby performing a precoding process shown in equation 13.

$$[ \begin{matrix}{x}_{1} ( m ) \\ {x}_{2} ( m )\end{matrix} ] = G [ \begin{matrix}{s}_{1} ( m ) \\ {s}_{2} ( m )\end{matrix} ] \qquad ( 13 )$$

In a case where π/2-BPSK is used by the data modulators 104c and 104d, the precoder 105a uses, for example, a precoding matrix G shown in equation 2, equation 2-3, or equation 2-5.

In a case where π/2-QPSK is used in the data modulators 104c and 104d, the precoder 105a uses, for example, a precoding matrix G shown in equation 14.

$$G = \frac{1}{\sqrt{5}} [ \begin{matrix}1 & 2 \\ - 2 & 1\end{matrix} ] \qquad ( 14 )$$

In a case where the precoder 105a performs precoding on a π/2-BPSK symbol using equation 2, constellation is similar to that of π/2-QPSK (see FIG. 4C). In a case where the precoder 105a performs precoding on a π/2-QSPK symbol (see FIG. 10A) using equation 14, constellation is similar to that of 16QAM (see FIG. 10B).

The number of symbol candidate points in π/2-BPSK is 2, the number of symbol candidate points in π/2-QPSK is 4, and the number of symbol candidate points in π/2-16QAM is 16. That is, precoding results in an increase in the number of symbol candidate points in constellation.

A second transmission RF chain process is performed differently depending on the modulation scheme and the type of the precoding matrix G. In a case where π/2-BPSK is used in the data modulators 104c and 104d and a precoding matrix G shown in equation 2, equation 2-3, or equation 2-5 is used in the precoder 105a, the transmission apparatus 300 performs the second transmission RF chain process using a complex conjugate GI adder 106b and a symbol order reverser 107 as with the transmission apparatus 100 shown in FIG. 3.

The complex conjugate GI adder 106b adds a complex conjugate of GI to an output x₂(m) output from the precoder 105a. The symbol order reverser 107 performs a symbol order reversion process on the output x₂(n) added with the complex conjugate of GI.

In a case where π/2-QPSK is used in the data modulators 104c and 104d and the precoding matrix G shown in equation 14 is used in the precoder 105a, the transmission apparatus 300, unlike the transmission apparatus 100 shown in FIG. 3, performs the second transmission RF chain process using a GI adder 106c.

The GI adder 106c adds, to the output x₂(m) output from the precoder 105a, the same GI as the GI added by the GI adder 106a in the first RF chain process.

Note that the GI adder 106c may add GI (GI₂) which is different from GI (GI₁) added by the GI adder 106a. Series which are orthogonal to each other (cross-correlation is 0) may be respectively used as Gl₁ and GI₂. For example, a Ga64 series defined in the 11 ad standard (see IEEE802.11ad™-2012, Dec. 28, 2012) may be used as GI₁, and a Gb64 series defined in the 11 ad standard may be used as GI₂.

A combination of π/2-BPSK modulation and the precoding matrix G according to equation 2, equation 2-3, or equation 2-5 is referred to as a first precoding scheme type. A combination of π/2-QPSK modulation and the precoding matrix G according to equation 14 is referred to as a second precoding scheme type. A method of distinguishing between the first precoding scheme type and the second precoding scheme type will be described later.

In a case where the first precoding scheme type is used, a selector 112a selects an output of a data symbol buffer 108a, and a selector 112b selects an output of a symbol order reverser 107.

In a case where the second precoding scheme type is used, the selector 112a selects an output of the GI adder 106a, and the selector 112b selects an output of the GI adder 106c.

Note that the selector 112a may be disposed at a stage following the GI adder 106a, and the selector 112b may be disposed at a stage following the precoder 105a.

Next, an explanation is given as to a reason why the transmission apparatus 300 changes the second transmission RF chain process depending on the precoding scheme.

In the first precoding scheme type, x₁(b, n) and x₂(b, n) are in complex conjugate relationship with each other as can be seen in equation 2-2, equation 2-4, or equation 2-6, and they are in a constant multiple relationship with each other. Therefore, in frequency domain, as shown in FIG. 5B and FIG. 5C, the signal subjected to the second transmission RF chain process is a signal obtained as a result of inverting frequencies of the signal subjected to the first transmission RF chain process and is in a complex conjugate relationship with the signal subjected to the first transmission RF chain process.

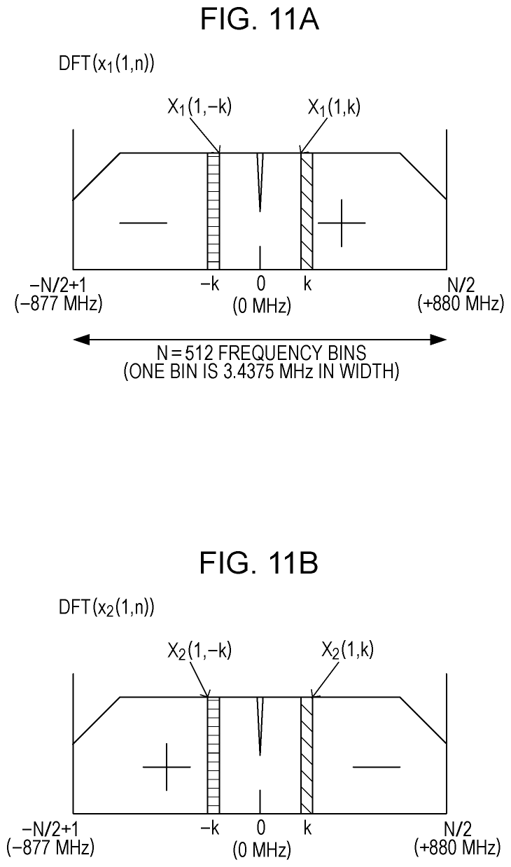

On the other hand, in the second precoding scheme type, x₁(b, n) and x₂(b, n) are not in a complex conjugate relationship. Therefore, in frequency domain, as shown in FIG. 11A and FIG. 11B, the signal subjected to the first transmission RF chain process and the signal subjected to the second transmission RF chain process are transmitted at the same frequency. For example, X₁(b, k) and X₂(b, k) are transmitted at an identical frequency, and X₁(b, −k) and X₂(b, −k) are transmitted at an identical frequency.

In a case where a complex number b satisfying equation 15 exists, the precoding scheme is of the first precoding scheme type.

x₂(m)=bx*₁(m) (15)

Thus, from the above consideration, when the first precoding scheme type is used, the transmission apparatus 300 adds a complex conjugate GI in the second transmission RF chain process and performs a symbol order reversion. That is, the selector 112b selects the output from the symbol order reverser 107. On the other hand, for the second precoding scheme type, in the second RF chain process, the same GI as that employed in the first RF chain process is added, but the symbol order reversion is not performed. That is, the selector 112b selects the output from the GI adder 106c.

Thus, the transmission apparatus 300 can achieve a frequency diversity effect depending on the phase shift θ given by the phase shifter 109 (and d calculated from θ according to equation 9-1) regardless of the data modulation scheme and the type of the precoding matrix, as shown in FIG. 6E and FIG. 6F.

In π/2-BPSK, when the precoding matrix shown in equation 2 is used, the constellation after the precoding is performed is identical to that in QPSK (see FIG. 4B). In this case, the precoding scheme is of the first precoding scheme type. In π/2-QPSK, when the precoding matrix shown in equation 14 is used, the constellation after the precoding is performed is identical to that in 16QAM (see FIG. 10B). In this case, the precoding scheme is of the second precoding scheme type.

Note that in π/2-BPSK modulation, the selectors 112a and 112b may select input data depending on the type of the precoding scheme.

The transmission apparatus 300 may employ the same transmission parameters in transmission as those in π/2-QPSK and π/2-16QAM used when transmission is performed without performing precoding. The transmission parameters include, for example, setting values of back-off of RF amplifiers in the transmission F/E circuits 110a and 110b. That is, the transmission apparatus 300 may perform precoding using equation (2) or (14) depending on the modulation scheme. This makes it possible to perform transmission without changing the configurations of the transmission F/E circuits 110a and 110b. A reason for this is described below.

In general millimeter wave communications, a setting value of back-off for an RF amplifier in a transmission F/E circuit is set or changed properly depending on transmission constellation mapping (FIG. 10A, FIG. 10B, etc.). For example, in 16QAM such as that shown in FIG. 10B, peak power (PAPR) relative to average power is large, and thus the back-off of the RF amplifier is set to be large such that saturation of a signal does not occur in the RF amplifier. Performing of the precoding process can cause a change in constellation mapping of the transmission signal, and thus setting of the transmission F/E circuit is changed.

In contrast, in the transmission apparatus 300 according to the present embodiment, by performing the precoding process using equation 2 or equation 14, it is possible to obtain constellation mapping which is the same as the constellation mapping in known modulation although the constellation mapping becomes different from that which was before the precoding process was performed. That is, the transmission signal has known constellation mapping regardless of whether the precoding process is performed or not, and thus it becomes unnecessary to change the configuration and setting of the transmission F/E circuit, and controlling becomes easy.

### Effects of Second Embodiment

In the second embodiment, in a case where the first precoded symbol and the second precoded symbol are in complex conjugate relationship, the transmission apparatus 300 adds, to the second precoded symbol, a complex conjugate of GI added to the first precoded symbol, performs symbol order reversion, and gives a phase shift (phase changing).

This makes it possible to switch among a plurality of data modulation schemes in MIMO channels, and thus it is possible to achieve a great frequency diversity effect. Furthermore, it is also possible to reduce the error rate in communication data and enhance the data throughput.

### Third Embodiment

A third embodiment discloses another method, different from the method according to the second embodiment, of performing MIMO transmission while switching the data modulation scheme among a plurality of schemes (for example, between π/2-BPSK modulation and π/2-QPSK modulation).

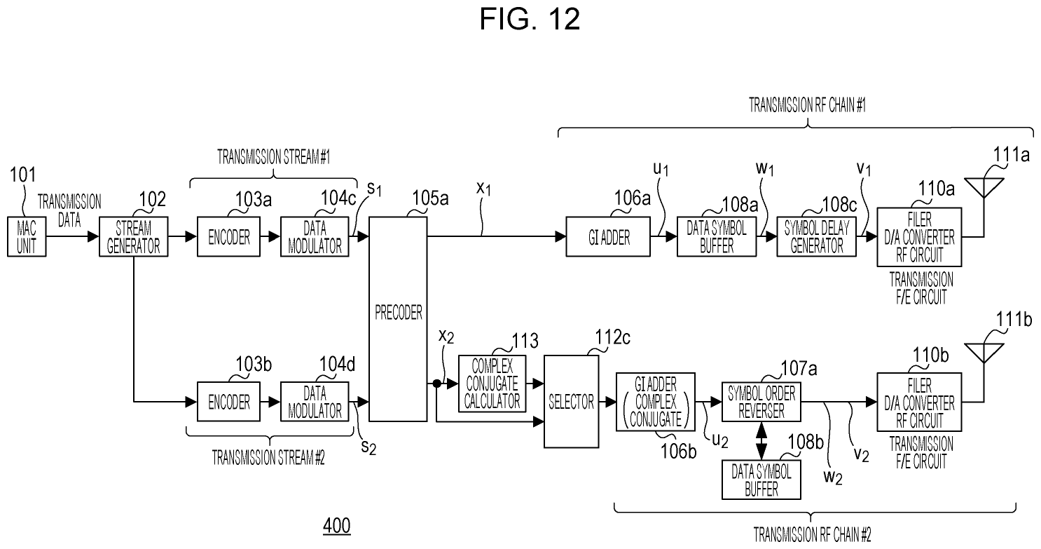

FIG. 12 is a diagram illustrating an example of a configuration of a transmission apparatus 400 according to the third embodiment. Note that in FIG. 12, same constituent elements as those in FIG. 9 are denoted by similar reference numerals, and a description thereof is omitted.

The precoder 105a outputs data symbol (x₂) for the transmission RF (Radio Frequency) chain #2 to the complex conjugate calculator 113 and the selector 112c. The complex conjugate calculator 113 calculates the complex conjugate of the received data symbol (x₂).

In a case where the precoder 105a performs precoding according to the first precoding scheme, the selector (selection circuit) 112c selects an output from the precoder 105a. In a case where the precoder 105a performs precoding of the second precoding scheme type, the selector (selection circuit) 112c selects an output from the complex conjugate calculator 113. Therefore, in a case where the transmission apparatus 400 selects the second precoding scheme type, the transmission apparatus 400 calculates the complex conjugate of a data symbol (x₂) for the transmission RF chain #2 output from the precoder 105a.

The symbol order reverser 107a performs the symbol order reversion on GIs and on data symbols (see FIG. 6A and FIG. 6B). Note that the transmission apparatus 400 performs, using the symbol order reverser 107a, the symbol order reversion regardless of the precoding scheme type.

The symbol delay generator 108c gives a delay, equal to or greater than a time corresponding to one symbol, to the output symbol from the data symbol buffer 108a. That is, the symbol delay generator 108c creates the delay such that the transmission of the transmission symbol from the transmission RF chain #1 is delayed with respect to the transmission of the transmission symbol from the transmission RF chain #2.

For example, the symbol delay generator 108c gives a one-symbol delay. This causes a first symbol from the transmission RF chain #1 and a second symbol from the transmission RF chain #2 to be transmitted at the same time.

When the symbol delay generator 108c gives a one-symbol delay, a predetermined dummy symbol may be output from the transmission RF chain #1 when the first symbol is transmitted from the transmission RF chain #2. The symbol delay generator 108c may use, for example, a last GI symbol as the dummy symbol. For example, in a case where the symbol delay generator 108c add a three-symbol delay, the symbol delay generator 108c may use three symbols located at the end of the GI as the dummy symbols.

Note that the symbol delay generator 108c may be disposed in the transmission RF chain #2 instead of in the transmission RF chain #1. For example, the symbol delay generator 108c may be disposed between the symbol order reverser 107a and the transmission F/E circuit 110b.

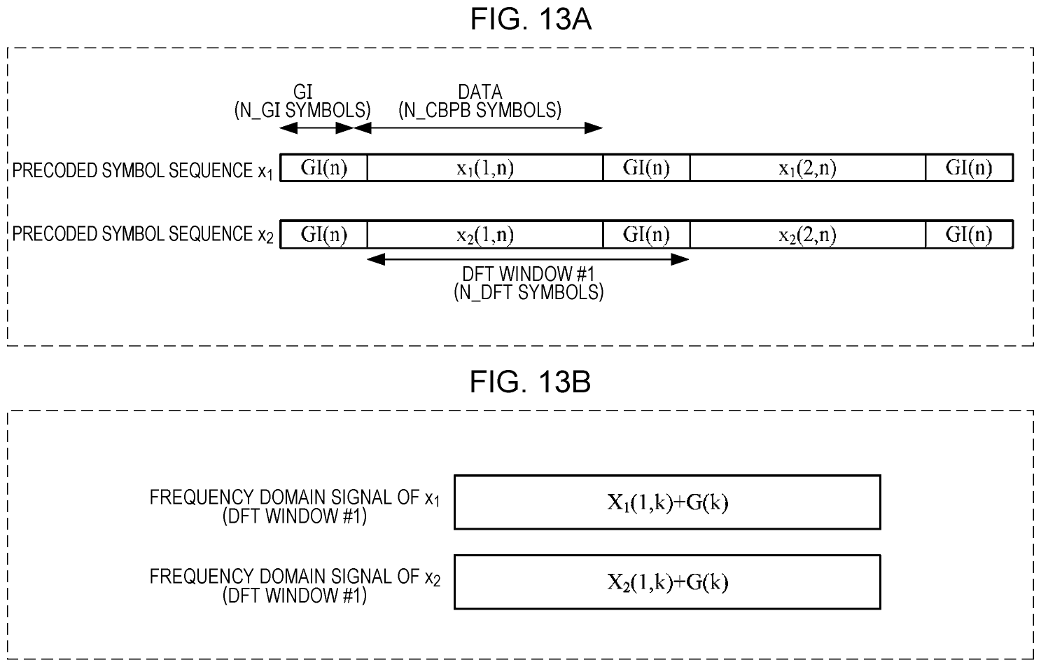

FIG. 13A is a diagram illustrating an example of a set of symbol sequences (precoded symbol sequences x₁ and x₂) output by the precoder 105a. Note that each precoded symbol sequence includes a series of precoded symbols and a series of GI symbols.

In FIG. 13A, x₁(b, n) and x₂(b, n) respectively denote n-th precoded symbols of b-th symbol blocks of the transmission RF chain #1 and the transmission RF chain #2. GI(n) is a GI output by GI adder 106a.

In FIG. 13A, N_DFT denotes a DFT window size (the number of symbols), N_CBPB denotes the number of symbols of data in the DFT window, and N_GI denotes a GI length (the number of symbols). For example, N_DFT may be 512 symbols, N_CBPB may be 448 symbols, and N_GI may be 64 symbols.

In the present embodiment, in x₁(b, n) and x₂(b, n) each representing a precoded symbol, n takes a value from 0 (inclusive) to N_CBPB (exclusive). In GI(n) representing a symbol of GI, n takes a value from N_CBPB (inclusive) to N_DFT (exclusive).

For example, in a case where the number of data symbols (N_CBPB) is equal to 448, and the GI length (N_CB) is equal to 64, in the data symbol x₁(1, n), n takes a value from 0 (inclusive) to 448 (exclusive). In GI(n), n takes a value from 448 (inclusive) to 512 (exclusive).

FIG. 13B is a diagram illustrating frequency-domain signals of x₁ and x₂ calculated by performing DFT in a DFT window #1 on precoded symbol sequences x₁ and x₂. The DFT window #1 has a width of N_DFT symbols. First symbols (at a location of n=0) are x₁(b, 0) and x₂(b, 0), respectively, and last symbols (at a location of n=511) are GI (511).

The frequency-domain signal of the precoded symbol sequence x₁ is a signal obtained by adding a signal component (X₁(b, k) where k is an integer from 0 (inclusive) to N_DFT (exclusive)) obtained by performing DFT on the precoded symbol x₁(b, n) (n is an integer from 0 (inclusive) to N_CBPB (exclusive)) and a signal component (G(k) where k is an integer from 0 (inclusive) to N_DFT (exclusive)) obtained by performing DFT on GI(n) (n is an integer from N_CBPB (inclusive) to N_DFT (exclusive)).

Note that the signal X₁(b, k) obtained as a result of performing DFT on the precoded symbol x₁(b, n) is a signal obtained by, in the DFT window #1, replacing values of the GI part with 0 and then performing DFT. The signal G(k) obtained as a result of performing DFT on GI(n) is a signal obtained by, in the DFT window #1, replacing values of the part other than the GI part with 0 and then performing DFT.

Similarly, the frequency-domain signal of the precoded symbol sequence x₂ is a signal obtained by adding a signal component (X₂(b, k) where k is an integer from 0 (inclusive) to N_DFT (exclusive)) obtained by performing DFT on the precoded symbol x₂(b, n) (n is an integer from 0 (inclusive) to N_CBPB (exclusive)) and a signal component (G(k) where k is an integer from 0 (inclusive) to N_DFT (exclusive)) obtained by performing DFT on GI(n) (n is an integer from N_CBPB (inclusive) to N_DFT (exclusive)).

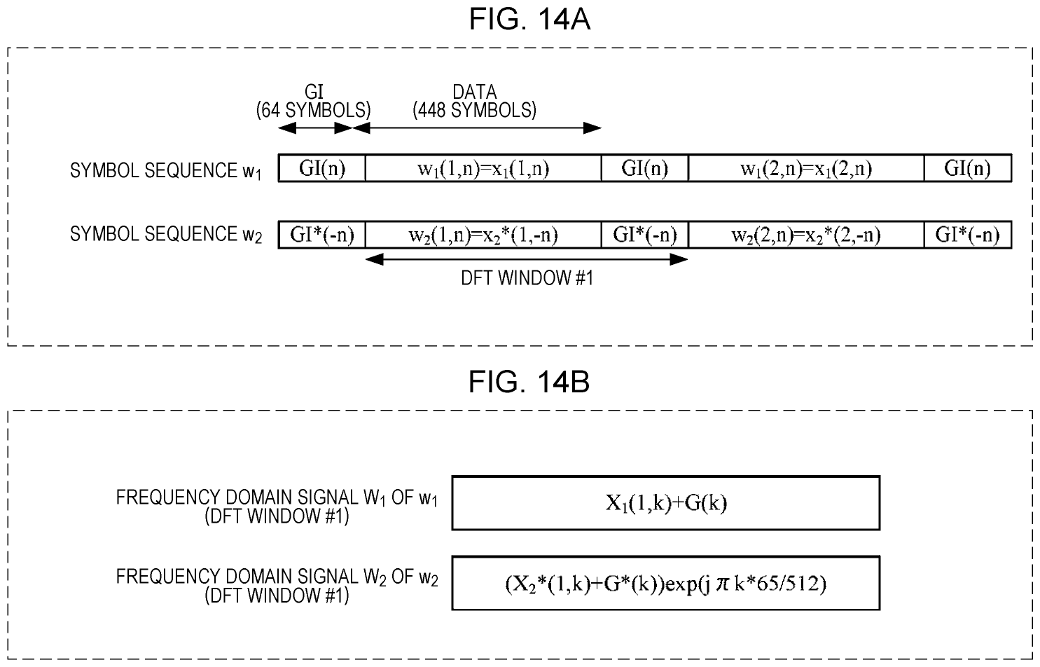

FIG. 14A is a diagram illustrating an example of a symbol sequence (w₁) output by the data symbol buffer 108a and an example of a symbol sequence (w₂) output by the symbol order reverser 107a for the case of a second precoding scheme type.

GI symbols of symbol sequences w₁ and w₂ are each GI*(−n) where GI*(−n) is a symbol sequence obtained by time-reversing the complex conjugate of GI(n). GI*(−n) is equal to the complex conjugate of GI(N_DFT-n+N_CBPC-1). For example, in a case where the value of N_DFT is equal to 512, the value of N_CBPB is equal to 448, and the value of N_GI is equal to 64, GI(−511) is equal to the complex conjugate of the value of GI(448).

A data symbol w₁(b, n) of the symbol sequence w₁ is equal to the value of x₁(b, n) and is expressed by equation (16-1). A data symbol w₂(b, n) of the symbol sequence w₂ is a symbol sequence obtained by performing symbol order reversion of the complex conjugate of x₂, and is represented by equation (16-2).

w₁(b,n)=x₁(b,n) (16-1)

w₂(b,n)=x*₂(b,−n) (16-2)

FIG. 14B is a diagram illustrating frequency-domain signals (W₁ and W₂) of w₁ and w₂ calculated by performing DFT, in a DFT window #1, on symbol sequences w₁ and w₂ shown in FIG. 14A. W₁(b, k) and W₂(b, k) are respectively represented by equation (17) and equation (18).

W₁(b,k)=X₁(b,k) (17)

W₂(b,k)=X*₂(b,k)e^{jπk(N_GI+1)/N_DFT} (18)

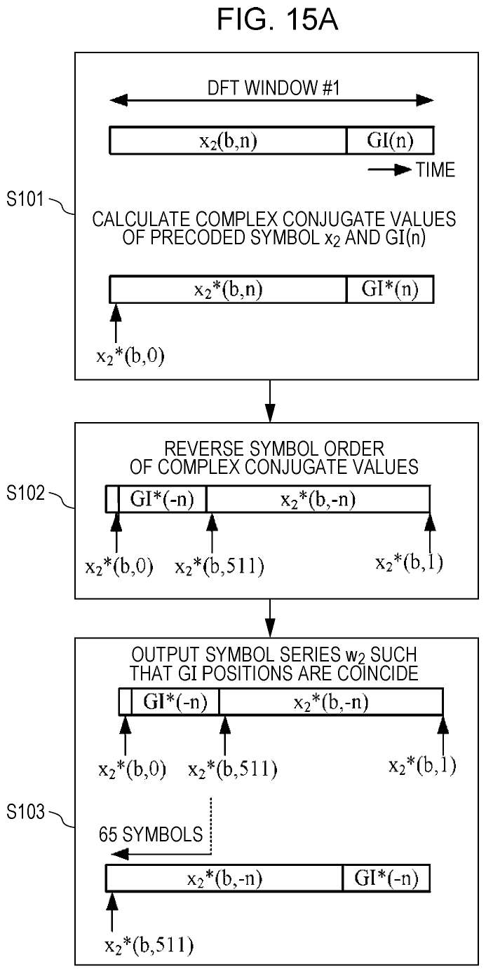

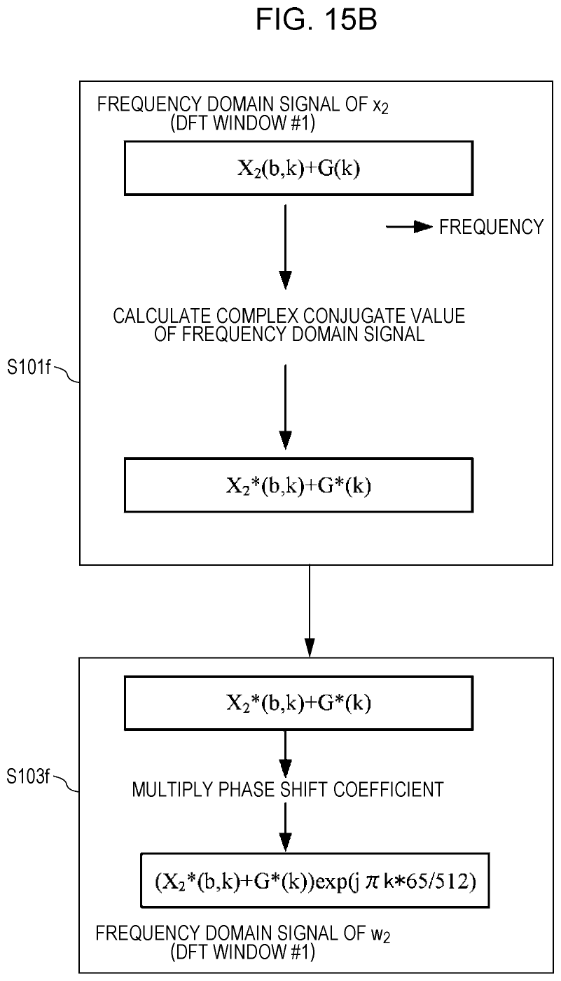

Next, referring to FIGS. 15A and 15B, a reason why the frequency-domain signal W₂(b, n) of the symbol sequence w₂ is expressed by equation (18) is described below. FIG. 15A is a flow chart illustrating, in a time domain, a process performed by the complex conjugate calculator 113 and the symbol order reverser 107a on the symbol sequence x₂. FIG. 15B is a flow chart illustrating, in a frequency domain, a process performed by the complex conjugate calculator 113 and the symbol order reverser 107a on the symbol sequence x₂.

The complex conjugate calculator 113 and the GI adder 106b calculate the values of complex conjugates of the precoded symbol x2(b, n) and GI(n) forming the symbol sequence x₂. As a result, x*₂(b, n) and GI*(n) are obtained (step S101 in FIG. 15A).

First, the symbol order reverser 107a reverses the symbol order in the DFT window #1. Note that the symbol order reverser 107a does not change the position of a first symbol (x*₂(b, 0)) but changes the order of the other symbols (step S102 in FIG. 15A). For example, the symbol order reverser 107a moves symbol positions n=0, 1, 2, 3, . . . , 511 to symbol positions n=0, 511, 510, 509, . . . , 2, 1.

The signal obtained as a result of performing DFT on the symbol sequence obtained in step S102 in FIG. 15A is the complex conjugate of the frequency-domain signal of the precoded symbol sequence x₂. The transmission apparatus 400 performs the processes in step S101 and step S102 thereby converting the precoded symbol sequence to the signal which is complex conjugate in the frequency domain to the precoded symbol sequence (step S101f in FIG. 15B). The transmission apparatus 400 may perform DFT, complex conjugate, and inverse DFT instead of performing the steps S101 and S102 in FIG. 15A thereby performing the step S101f in FIG. 15B.

The symbol order reverser 107a performs cyclic shifting on the signal obtained in the step S102 in FIG. 15A such that the position of GI of the precoded symbol sequence x₁ and the position of GI of the symbol sequence w₂ are coincident with each other (step S103 in FIG. 15A). The symbol order reverser 107a performs cyclic shifting on the signal obtained in step S102 to the left (in a negative direction) by N_GI+1 symbols (for example, 65 symbols). As a result of step S103, the symbol sequence w₂ is obtained.

The cyclic shifting by N_GI+1 symbols in the time domain corresponds to multiplication by phase shift coefficients (exp(jπ(N_GI+1)/N_DFT)) in the frequency domain (step S103f in FIG. 15B).

It has been explained above that the data symbol w₂(b, n) of the symbol sequence w₂ is expressed by equation (18).

Equations (17) and (18) indicate that the transmission apparatus 400 does not perform phase shift in the frequency domain on the precoded symbol x₁ but performs phase shift in the frequency domain on the precoded symbol x₂. This is equivalent to a process in which the complex conjugate calculator 113 and the symbol order reverser 107a perform precoding depending on the frequency bin number k in frequency domain according to equation 19 shown below.

$${G}_{r} ( k ) = [ \begin{matrix}1 & 0 \\ 0 & {e}^{j π k ( N \_ GI + 1 ) / N \_ DFT}\end{matrix} ] \qquad ( 19 )$$

If the process is further combined with a process performed by the precoder 105a using the precoding matrix G, the combined total process is equivalent to a process in which the transmission apparatus 400 performs precoding according to Gr(k)×G and transmits a result.

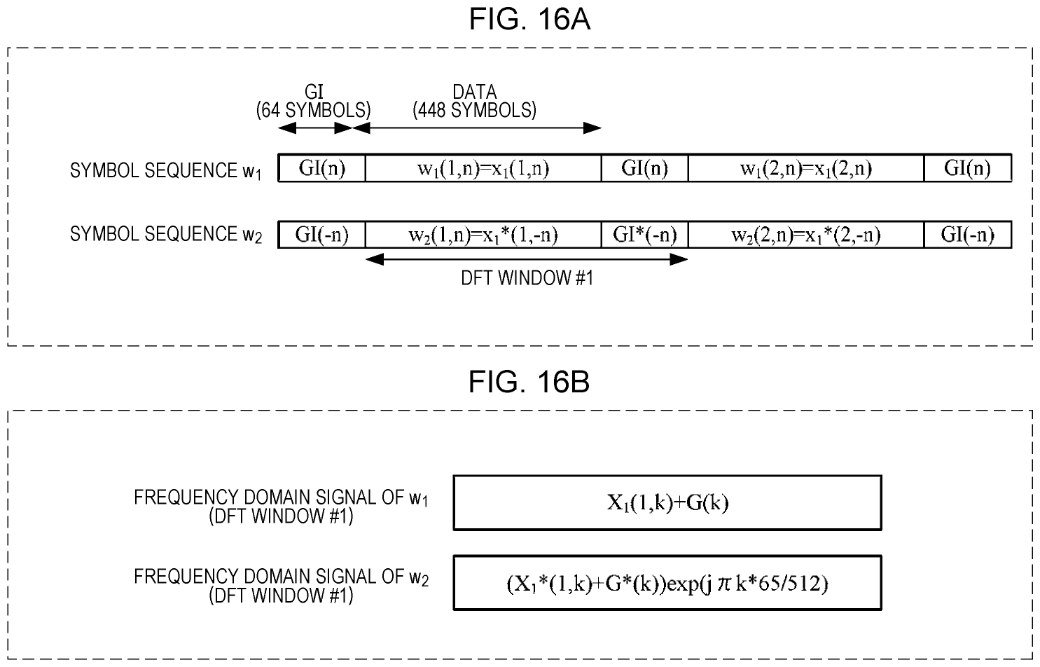

FIG. 16A illustrates an example of a set of symbol sequences (precoded symbol sequences x₁ and x₂) output by the precoder 105a for the case of a first precoding scheme type. FIG. 16B is a diagram illustrating frequency-domain signals of w₁ and w₂ calculated by performing DFT, in the DFT window #1, on the symbol sequences w₁ and w₂ shown in FIG. 16A.

In the first precoding scheme type, the precoded symbols x₁ and x₂ satisfy a relationship expressed in equation 2-2, equation 2-4, or equation 2-6. A further explanation is given below, by way of example, for a case where x₂(b, n) is complex conjugate to x1(b, n), that is, equation (2-2) is satisfied.

The output symbol sequences shown in FIG. 16A are equal to output symbol sequences obtained by replacing x₂ with x₁ in the output symbol sequences shown in FIG. 14A. Therefore, time-domain signals of the symbol sequences w₁ and w₂ are represented by equations (20) and (21), and frequency-domain signals of the symbol sequences w₁ and w₂ are represented by equations (22) and (23).

w₁(b,n)=x₁(b,n) (20)

w₂(b,n)=x*₁(b,−n) (21)

W₁(b,k)=X₁(b,k) (22)

W₂(b,k)=X*₁(b,k)e^{jπk(N_GI+1)/N_DFT} (23)

In the case of the first precoding scheme type, as in the case of the second precoding scheme type, according to equations (22) and (23), the transmission apparatus 400 is capable of obtaining a result of the operation of the precoding matrix shown in equation (19).

As described above, the transmission apparatus 400 performs the complex conjugate conversion, depending on the precoding scheme type, on the precoded symbol x₂ and further performs the symbol order reversion process. Thus, the transmission apparatus 400 can obtain a result equal to a result obtained by performing precoding depending on the frequency bin number k, and can make transmission such that the precoding matrix is different depending on the frequency bin number k. Thus, a frequency diversity effect and improvement in reception quality are achieved.

In a case where the reception apparatus 200 shown in FIG. 7 receives a transmission signal from the transmission apparatus 400 shown in FIG. 12, the inverse phase shifter 208 may remove a phase shift according to equation (19). Furthermore, in the reception apparatus 200, the MMSE weight calculation unit 206 may multiply the channel matrix by the phase shift according to equation (19) and may remove the phase shift according to equation (19) from the output of the MMSE filter 207. Furthermore, in the reception apparatus 200, the IDFT and the symbol order reverser 209b may perform shifting on the reception symbol sequences in a direction opposite to that in step S103 in FIG. 15A and may remove the phase shift according to equation (19).

Note that in the precoding performed by the precoder 105a, the precoding matrix of the first precoding scheme type may be converted to a precoding matrix of the second precoding scheme type, and then the precoding may be performed. In this case, the transmission apparatus 400 uses the complex conjugate calculator 113 regardless of the modulation scheme and thus the selector 112c may not be provided. This allows a reduction in the circuit complexity of the transmission apparatus 400.

Equation (24) represents an example of a precoding matrix obtained as a result of converting the precoding matrix in equation (2) to the second precoding scheme type.

$$G = \frac{{e}^{- j \frac{π}{4}}}{\sqrt{2}} [ \begin{matrix}1 & j \\ 1 & j\end{matrix} ] \qquad ( 24 )$$

In FIG. 12, the symbol delay generator 108c gives a delay corresponding to a predetermined number of symbols (d symbols where d is an integer) to the symbol sequence w₁. This results in a change in transmission signal timing between the transmission RF chain #1 and the transmission RF chain #2.

In the case where the delay d is added by the symbol delay generator 108c, resultant time-domain symbol sequence signals v₁ and v₂ are represented by equations (25) and (26). Frequency-domain signals V₁ and V₂ of the symbol sequences v₁ and v₂ are represented by equations (27) and (28).

v₁(b,n)=x₁(b,n−d) (25)

v₂(b,n)=x*₂(b,−n) (26)

V₁(b,k)=X₁(b,k) (27)

V₂(b,k)=X*₂(b,k)e^{jπk(N_GI+d+1)/N_DFT} (28)

Comparing equation 18 (for a case where no delay is added) with equation 28 indicates that equation 28 provides a greater amount of phase shift than is provided by equation 18. Therefore, the transmission apparatus 400 adds a delay to the symbol sequence of the transmission RF chain #1. As a result, an increase in diversity effect and an improvement in reception quality are achieved.

In a case where values of N_GI and N_DFT are even, the symbol delay generator 108c may employ an odd number as the amount of delay d. This causes values (N_GI+d+1)/N_DFT included in coefficients of the amount of phase shift in equation 28 to be reduced to a common denominator, and equation 29 is satisfied. As a result, the amount of phase shift becomes equal between a frequency bin k and a frequency bin k+N_DFT/2.

e^{jπk(N_GI+d+1)/N_DFT}=e^{jπ(k+N_DFT/2(N_GI+d+1)/N_DFT} (29)

According to equation (29), the inverse phase shifter 208 of the reception apparatus 200 calculates the amount of phase shift of either one of frequency bin k and the frequency bin k+N_DFT/2. This results in a reduction by half in the calculation of the amount of phase shift, which allows a reduction in circuit complexity.

In a case where the value of N_DFT is a multiple of 4, the symbol delay generator 108c sets the value of the amount of delay d such that N_GI+d+1 is equal to a multiple of 4. As a result, the amount of phase shift becomes equal for four frequency bins k, k+N_DFFT/4, k+N_DFFT/2, and k+N_DFFT×¾. Thus, a further reduction can be achieved in the amount of calculation performed by the reception apparatus 200.

Similarly, in a case where N_DFT is a multiple of a power of 2, the symbol delay generator 108c sets the amount of delay d such that N_GI+d+1 is equal to a multiple of a power of 2. This allows a reduction in the circuit complexity of the reception apparatus 200.

An increase in the amount of delay d causes in increase in the difference in position of GI between the transmission RF chain #1 and the transmission RF chain #2. To handle the above situation, the value of d may be set to be smaller than or equal to the number of symbols of GI. The symbol delay generator 108c may determine the value of the amount of delay d depending on the GI length. For example, in a case where the GI length is 64, the symbol delay generator 108c may set the value of d to one of 1, 3, 7, and 15. For example, in a case where the GI length is 128, the symbol delay generator 108c may set the value of d to one of 3, 7, 15, and 31.

The transmission apparatus 400 may insert the symbol delay generator 108c in the transmission RF chain #2 instead of in the transmission RF chain #1. In this case, the frequency-domain signal V2 of the symbol sequence v₂ is represented by not equation (29) but equation (30).

V₂(b,k)=X*₂(b,k)e^{jπk(N_GI-d+1)/N_DFT} (30)

In a case where values of N_GI and N_DFT are even, the symbol delay generator 108c may set the amount of delay d to an odd number, which allows a reduction in the circuit complexity of the reception apparatus 200. In a case where the value of N_DFT is equal to a power of 2, the symbol delay generator 108c may determine the amount of delay d such that the value of N_GI−d+1 is equal to power of 2. This allows a reduction in the circuit complexity of the reception apparatus 200.

### Effects of the Third Embodiment

In the third embodiment described above, the transmission apparatus 400 performs the complex conjugate conversion, depending on the precoding scheme type, on the precoded symbol x₂ and further performs the symbol order reversion process. As a result, the transmission apparatus 400 obtains a result equal to a result obtained by performing precoding depending on the frequency bin number k.

Thus, it is possible to achieve a large frequency diversity effect in MIMO channels. Furthermore, it is possible to achieve a reduction in communication error rate and an increase in data throughput.

### Fourth Embodiment

A fourth embodiment discloses another method, different from the second embodiment, of performing MIMO transmission such that a plurality of data modulation schemes (for example, π/2-BPSK modulation and π/2-QPSK modulation) are switched.

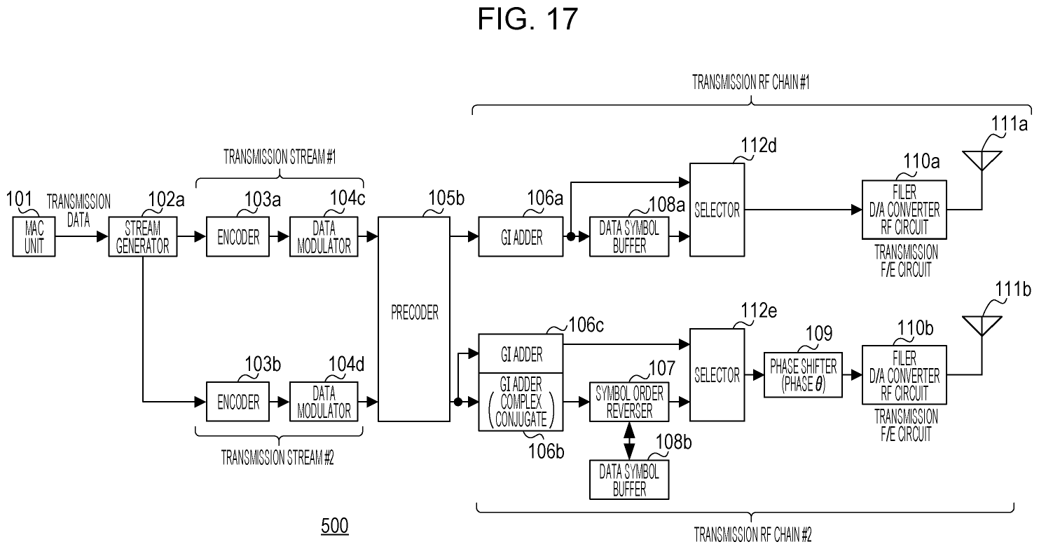

FIG. 17 is a diagram illustrating a configuration of a transmission apparatus 500 according to the fourth embodiment. Note that in FIG. 17, same constituent elements as those in FIG. 9 are denoted by similar reference numerals, and a description thereof is omitted.

A stream generator 102a, unlike the stream generator 102 shown in FIG. 9, operates in two modes that are switched in accordance with an instruction given by a MAC unit 101. In one mode, two transmission streams are output, while in the other mode, one transmission stream is output.

In the mode in which the stream generator 102a outputs two transmission streams (this mode is referred to as a two-stream transmission), the transmission apparatus 500 operates in a similar manner to the transmission apparatus 300 shown in FIG. 9, and thus a further description is omitted.

Thus in the following description, an explanation is given as to an operation in the other mode in which the stream generator 102a outputs one transmission stream (this mode is referred to as a one-stream transmission). In this mode, the encoder 103b and the data modulator 104d may not operate.

The precoder 105b outputs two precoded symbols x₁ and x₂ for one input symbol. The precoder 105b performs, for example, precoding according to equation (31).

$$[ \begin{matrix}{x}_{1} ( m ) \\ {x}_{2} ( m )\end{matrix} ] = [ \begin{matrix}1 \\ 1\end{matrix} ] {s}_{1} ( m ) \qquad ( 31 )$$

In the precoding according to equation (31), the precoded symbols x₁ and x₂ have the same values. The precoder 105b distributes transmission energy equally to the two transmission antennas (the transmission RF chains) for one symbol. As a result, a space diversity effect is achieved.

The precoder 105b may perform precoding according to equation (32). The precoder 105b distributes transmission energy to two transmission RF chains and transmits the symbol such that the symbols are orthogonal to each other on I and Q axes. This provides further enhancement of diversity effect.

$$[ \begin{matrix}{x}_{1} ( m ) \\ {x}_{2} ( m )\end{matrix} ] = [ \begin{matrix}1 \\ j\end{matrix} ] {s}_{1} ( m ) \qquad ( 32 )$$

In the case where the stream generator 102a outputs one transmission stream, the selector 112d selects the output of the GI adder 106a while selector 112e selects the output of the GI adder 106c as in the second precoding scheme type.

Note that in the precoding matrices in equations (31) and (32), there is no complex conjugate relationship between the two precoded symbols, and thus the precoding matrices are of the second precoding scheme type.

In a case where the reception apparatus 200 receives a signal including one transmission stream, the MMSE filter 207 switches the operation such that one transmission stream is output. This results in a reduction in amount of calculation and a reduction in power consumption.

In a case where the transmission apparatus 500 performs one-stream transmission, a space-frequency diversity effect is achieved and thus an improvement in communication performance is achieved. Furthermore, a reduction in consumption power in the reception apparatus 200 is achieved.

Note that when the transmission apparatus 500 performs two-stream transmission, the transmission apparatus 500 transmits precoded symbols x₁ and x₂ different from each other. Therefore, a further enhancement of space-frequency diversity effect and a further improvement in communication performance are obtained compared with those achieved in one-stream transmission.

The transmission apparatus 500 may switch between the one-stream transmission and the two-stream transmission depending on the throughput. This results in a reduction in consumption power in the reception apparatus 200 and an enhancement of space-frequency diversity effect. As a result, an improvement in communication performance is achieved.

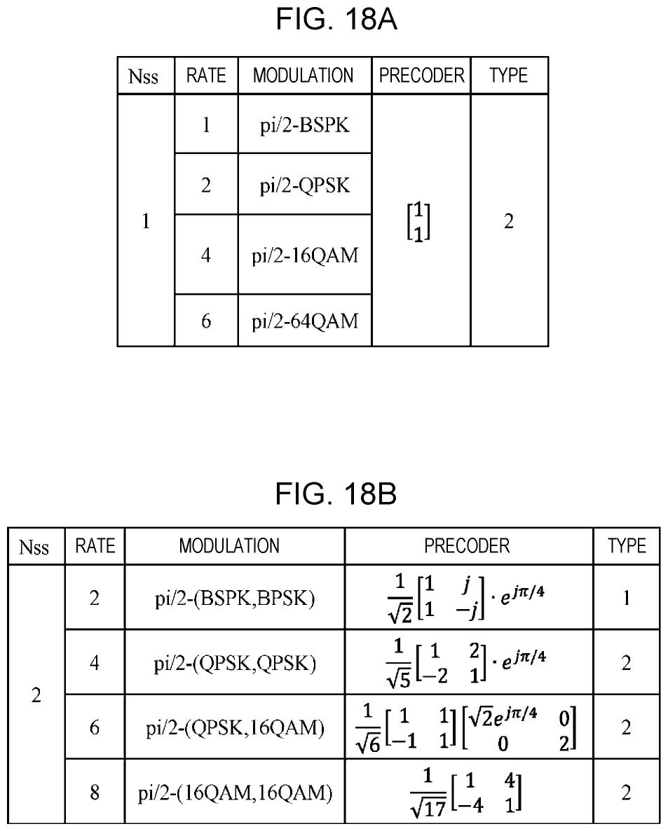

FIG. 18A illustrates an example of a precoding matrix in one-stream transmission. Nss denotes the number of streams, Rate denotes the number of transmission bits per one transmission symbol, Modulation denotes a modulation scheme, Precoder denotes a precoding matrix, and Type denotes a precoding scheme type. In Modulation, pi/2-BPSK denotes π/2-shift BPSK (Binary Phase Shift Keying), pi/2-QPSK denotes π/2-shift QPSK (Quadrature Phase Shift Keying), pi/2-16QAM denotes π/2-shift 16QAM (16-point Quadrature Amplitude Modulation), and pi/2-64QAM denotes π/2-shift 64QAM (64-point Quadrature Amplitude Modulation).

Thus, the transmission apparatus 500 uses the precoding matrix in one-stream transmission regardless of the modulation scheme.

FIG. 18B illustrates an example of a precoding matrix in two-stream transmission. In Modulation, pi/2-(BPSK, BPSK) indicates that π/2-shift BPSK is used in the transmission stream #1 and the transmission stream #2. pi/2-(QPSK, 16QAM) indicates that π/2-shift QPSK is used in the transmission stream #1 and π/2-shift 16QAM is used in the transmission stream #2.

In a case where in two-stream transmission, the modulation scheme is pi/2-(BPSK, BPSK), the transmission apparatus 500 uses a precoding matrix expressed in equation (33). The precoding matrix expressed in equation (33) provides a performance similar to that provided by the precoding matrix expressed in equation (2). Transmission symbols in transmission F/E circuits 110a and 110b have constellation points similar to those of π/2-shift QPSK (see FIG. 4C).

$$G = \frac{{e}^{j \frac{π}{4}}}{\sqrt{2}} [ \begin{matrix}1 & j \\ 1 & - j\end{matrix} ] \qquad ( 33 )$$

In a case where the modulation scheme is pi/2-(QPSK, QPSK), the transmission apparatus 500 uses a precoding matrix expressed in equation (34). The precoding matrix expressed in equation (34) provides a performance similar to that provided by the precoding matrix expressed in equation (14). By giving a phase shift, constellation points similar to those of π/2-shift 16QAM are obtained.

$$G = \frac{{e}^{j \frac{π}{4}}}{\sqrt{5}} [ \begin{matrix}1 & 2 \\ - 2 & 1\end{matrix} ] \qquad ( 34 )$$

In a case where the modulation scheme is pi/2-(QPSK, 16QAM), the transmission apparatus 500 uses a precoding matrix expressed in equation (35).

$$G = \frac{1}{\sqrt{6}} [ \begin{matrix}1 & 1 \\ - 1 & 1\end{matrix} ] [ \begin{matrix}\sqrt{2} {e}^{j π / 4} & 0 \\ 0 & 2\end{matrix} ] \qquad ( 35 )$$

Note that the precoding matrix in equation (35) can be expressed by a product of two precoding matrices G1 and G2.

$$\begin{matrix}{G}_{1} = \frac{1}{\sqrt{3}} [ \begin{matrix}\sqrt{2} {e}^{j π / 4} & 0 \\ 0 & 2\end{matrix} ] & ( 36 ) \\ {G}_{2} = \frac{1}{\sqrt{2}} [ \begin{matrix}1 & 1 \\ - 1 & 1\end{matrix} ] & ( 37 )\end{matrix}$$

The precoding matrix G₁ may be used to adjust power of the transmission stream #1 modulated by pi/2-QPSK and the transmission stream #2 modulated by pi/2-16QAM so as to maximize the MIMO channel capacity. The precoding matrix G₂ may be used to distribute the power-adjusted transmission stream #1 and transmission stream 2 to the transmission RF chain #1 and transmission RF chain #2 such that power is equal between the transmission RF chain #1 and transmission RF chain #2 and space diversity is obtained.

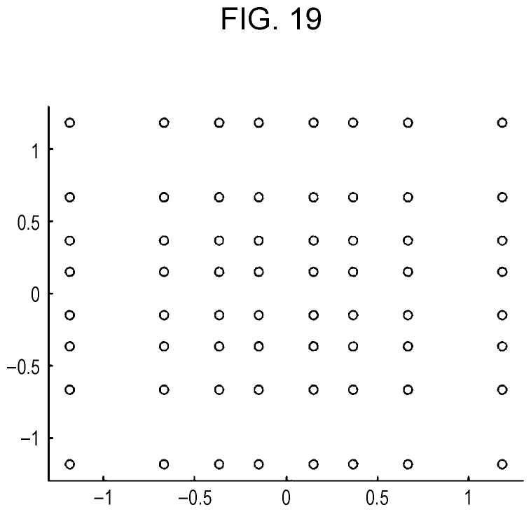

FIG. 19 illustrates an example of a set of constellation points for a case where the modulation scheme is pi/2-(QPSK, 16QAM). The constellation shown in FIG. 19 corresponds to a constellation obtained when a symbol point interval is changed in π/2-shift 64QAM.

In a case where the modulation scheme is pi/2-(16QAM, 16QAM), the transmission apparatus 500 uses a precoding matrix expressed in equation (38). The precoding matrix expressed in equation (38) provides constellation points similar to those of π/2-shift 256QAM (256-point QAM).

$$G = \frac{1}{\sqrt{17}} [ \begin{matrix}1 & 4 \\ - 4 & 1\end{matrix} ] \qquad ( 38 )$$

As described above, when the precoder 105b performs precoding of two streams, constellations of transmission symbols are similar to those of π/2-shift BPSK, π/2-shift QPSK, π/2-shift 16QAM, π/2-shift 64QAM, or π/2-shift 256QAM. Therefore, the transmission apparatus 500 can perform transmission with a low PAPR (Peak to Average Power Ratio).

Using the precoding matrices expressed in equations (34) and (38) by the transmission apparatus 500 is equivalent to performing transmission such that the power ratio between the transmission stream #1 and the transmission stream #2 is set to be different between the transmission RF chain #1 and the transmission RF chain #2. This makes it possible for the transmission apparatus 500 to enhance the space diversity effect.

Note that the transmission apparatus 500 according to the present embodiment is equivalent to a transmission apparatus obtained by modifying the transmission apparatus 300 shown in FIG. 9 such that switching is performed between the one-stream transmission and two-stream transmission. The transmission apparatus 500 according to the present embodiment is also equivalent to a transmission apparatus obtained by modifying the transmission apparatus 400 shown in FIG. 12 such that switching is performed between the one-stream transmission and two-stream transmission. In one-stream transmission, the precoding matrix is of the second precoding scheme type. In this case, the selector 112c in the transmission apparatus 400 selects the output from the complex conjugate calculator 113.

Note that in the one-stream transmission, the transmission apparatus 400 performs the complex conjugate conversion process and the symbol order reversion process on the signal of the transmission RF chain #2. Thus, a phase shift according to equation (19) is obtained, which allows it to achieve a frequency diversity effect, and thus an improvement in communication performance is achieved.

### Effects of Fourth Embodiment

In the fourth embodiment described above, the transmission apparatus 500 operates such that an operation mode is switched depending on whether two transmission streams are output or one transmission stream is output. In a case where a first precoded symbol and a second precoded symbol are complex conjugate to each other, the transmission apparatus 500 processes the second precoded symbol such that a complex conjugate of GI added to the first precoded symbol is added to the second precoded symbol the symbol order is reversed, and phase shifting (phase changing) is performed.

This makes it possible to switch among a plurality of data modulation schemes in a MIMO channel. As a result, a great frequency diversity effect is achieved. Furthermore, a reduction in communication data error rate and an improvement in data throughput are achieved.

### Modifications of Second Embodiment

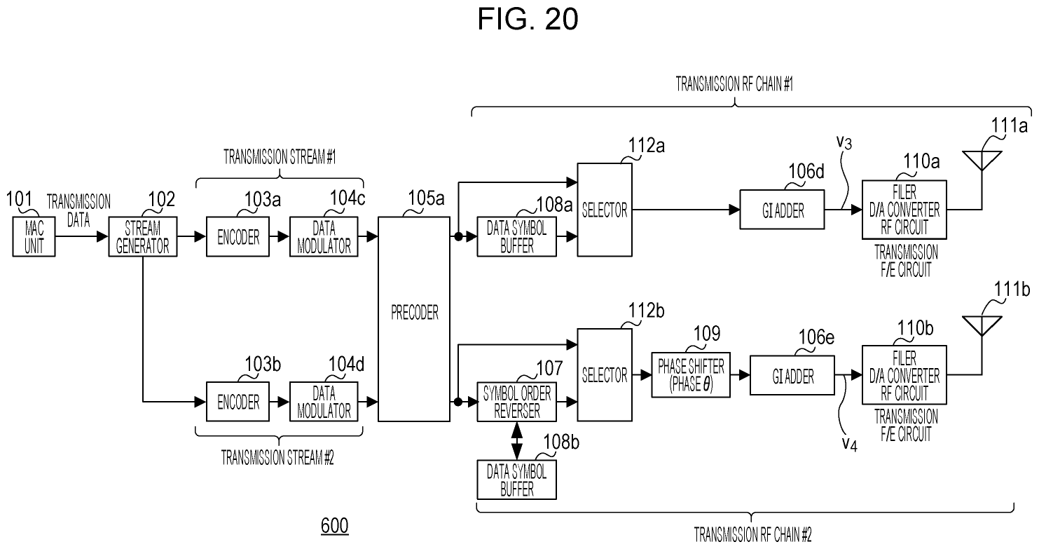

In the MIMO transmission according to the second embodiment described above, in the case of π/2-BPSK modulation, the transmission apparatus 300 operates such that the symbol order reverser 107 performs the symbol order reversion process on the data symbols and on the GI symbols. In a modification of the second embodiment described below, a transmission apparatus 600 (see FIG. 20) performs MIMO transmission such that GI adders 106d and 106e add different series (for example, series orthogonal to each other) on a stream-by-stream basis.

FIG. 20 is a diagram illustrating a configuration of a transmission apparatus 600 according to the modification of the second embodiment. Note that in FIG. 20, same constituent elements as those in FIG. 9 are denoted by similar reference numerals, and a description thereof is omitted.

The GI adder 106d is disposed at a stage following the selector 112a, and the GI adder 106e is disposed at a stage following the phase shifter 109 following the selection unit 112b. Unlike the transmission apparatus 300 shown in FIG. 9, the transmission apparatus 600 may add a GI symbol determined for each stream regardless of the modulation scheme.

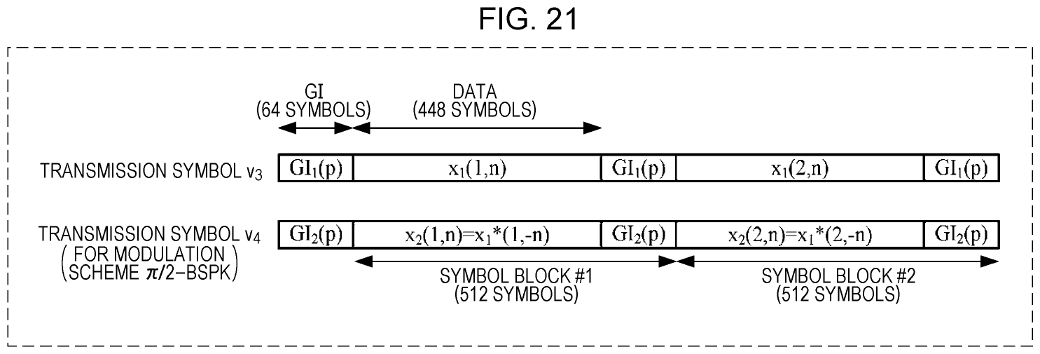

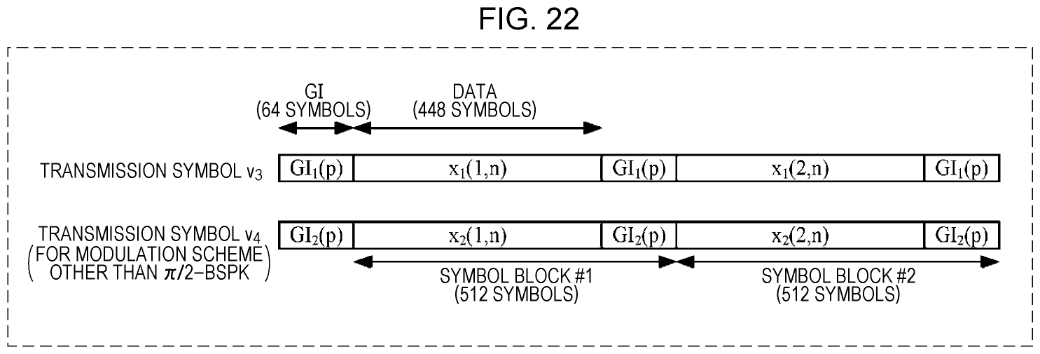

FIGS. 21 and 22 each illustrate an example of a transmission symbol format of outputs (v₃ and v₄) output from the GI adder 106d and 106e of the transmission apparatus 600. FIG. 21 illustrates a case where the data symbol is modulated by π/2-BPSK modulation. FIG. 22 illustrates a case where the data symbol is modulated by a modulation scheme other than π/2-BPSK modulation.

The GI adder 106d divides the precoded symbol x₁(m) into data blocks each including 448 symbols, and adds 64-symbol GI(GI₁(p)) in front of each data block. GI is a symbol sequence obtained by performing π/2-BPSK modulation on a known series. The GI adder 106d further adds 64-symbol GI following a last data block. As a result, a transmission symbol v₃ shown in FIG. 21 or 22 is generated. Note that the numbers of symbols employed above are merely examples, and the numbers of symbols in the present embodiment may be different from these examples.

Similarly, the complex conjugate GI adder 106e divides the precoded symbol x₂(m) into data blocks each including 448 symbols, adds a 64-symbol GI (GI₂(p)) in front of each data block, and adds a 64-symbol GI after a last data block. As a result, a transmission symbol v₄ such as that shown in FIG. 21 or 22 is generated. GI added by the GI adder 106e may be different from a series of GI added by the GI adder 106d.

In a case where a transmission signal in the format shown in FIG. 21 and FIG. 22 is received from the transmission apparatus 600, the reception apparatus 200 may perform MMSE equalization according to equation (12-2) as in the first embodiment in the reception process.

The reception apparatus 200 may detect an error of the channel estimation matrix by comparing the MMSE-equalized GI symbol (part associated with GI in the output from the MMSE filter 207) with a known GI symbol, and may correct the channel estimation matrix. In a case where GI₁(p) and GI₂(p) are orthogonal series, a calculation is performed to determine a correlation between the GI₁(p) estimated by MMSE equalization and the known GI₁(p). As a result of this calculation, a residual error of MMSE equalization is reduced and, for example, a value of phase shift is calculated with high accuracy. Thus, it is possible to make a high-accuracy correction of a channel estimation matrix, which results in an improvement in reception performance.

Next, a description is given as to another method for the MMSE filter 207 of the reception apparatus 200 to receive a transmission signal in the format shown in FIG. 21 or FIG. 22 from the transmission apparatus 600.

The reception apparatus 200 generates replica signals of GI₁(p) and GI₂(p) according to equation (39). The replica signals are estimated values of signals received via a receiving antenna in a case where a known pattern (for example, GI₁(p) and GI₂(p)) is transmitted, the replica signals are calculated by multiplying the known pattern by the channel matrix (see equation (12)).

$$\{ \begin{matrix}{\hat{Y}}_{G 1} ( k ) = {H}_{11} ( k ) {X}_{G 1} ( k ) + {H}_{12} ( k ) {X}_{G 2} ( k ) \\ {\hat{Y}}_{G 2} ( k ) = {H}_{21} ( k ) {X}_{G 1} ( k ) + {H}_{22} ( k ) {X}_{G 2} ( k )\end{matrix} \qquad ( 39 )$$

In equation (39), X_{G1}(k) and X_{G2}(k) are signals (frequency domain signals of GI) obtained as a result of performing DFT on time-domain GI signals (symbols) GI₁(p) and GI₂(p). Y_{G1}(k) and Y_{G2}(k) are frequency-domain signals obtained when the reception apparatus 200 receives GI₁(p) and GI₂(p). A symbol \hat{ } added to Y_{G1}(k) and Y_{G2}(k) indicates that these are estimated values.

According to equation (40), the reception apparatus 200 subtracts Y\hat{ }_{G1}(k) from a reception signal Y₁(b, k) thereby estimating a data signal component Y\hat{ }_{D1}(k) included in the reception signal, and subtracts Y\hat{ }_{G2}(k) from a reception signal Y₂(b, k) thereby estimating a data signal component Y\hat{ }_{D2}(k).

$$\{ \begin{matrix}{\hat{Y}}_{D 1} ( b , k ) = {Y}_{1} ( b , k ) - {\hat{Y}}_{G 1} ( k ) \\ {\hat{Y}}_{D 2} ( b , k ) = {Y}_{2} ( b , k ) - {\hat{Y}}_{G 2} ( k )\end{matrix} \qquad ( 40 )$$

The reception apparatus 200 performs MMSE equalization on the estimated data signal component Y\hat{ }_{D1}(k) and Y\hat{ }_{D2}(k) given as input signals thereby calculating estimated values T\hat{ }_{D1}(k) and T\hat{ }_{D2}(k) of transmission data symbols.

$$[ \begin{matrix}{\hat{T}}_{D 1} ( b , k ) \\ {\hat{T}}_{D 2} ( b , k )\end{matrix} ] = {W}_{2 \times 2} ( k ) [ \begin{matrix}{\hat{Y}}_{D 1} ( b , k ) \\ {\hat{Y}}_{D 2} ( b , k )\end{matrix} ] \qquad ( 41 )$$

The calculation process performed in equation (41) is similar to that in equation (12-2), except that in contrast to equation (12-2) in which inputs Y₁(b, k) and Y₂(b, k) include signal components of data and GI, inputs Y\hat{ }_{D1}(k) and Y\hat{ }_{D2}(k) in equation (18) include only signal components of data remaining after subtracting the signal components of GI.

When a transmission signal from the transmission apparatus 600 is received, GI of each stream does not have a complex conjugate relationship and a time order converted relationship, and thus it is difficult for the MMSE filter 207 to achieve a frequency diversity effect in demodulation of the GI symbols similar to the frequency diversity effect achieved in the first embodiment. As a result, there is a possibility that intersymbol interference from GI symbols to data symbols remains after the MMSE equalization, which may result in degradation in reception performance.

In the receiving of a transmission signal from the transmission apparatus 600, the MMSE filter 207 subtracts the GI symbol replica from the reception signal using equation (39), equation (40), and equation (41) in the MMSE equalization. That is, the MMSE equalization of data symbols is performed after the effect of GI is reduced.

The reception apparatus 200 performs a reception process including inverse phase shift and inverse precoding on estimated values of transmission data symbols T\hat{ }_{D1}(k) and T\hat{ }_{D2}(k) generated by the MMSE filter 207 using equation (41), in a similar manner to the first embodiment and the second embodiment.

### Effects of Modifications of Second Embodiment

In the modification of the second embodiment, in a case where the first precoded symbol and the second precoded symbol are in a complex conjugate relationship, the transmission apparatus 600 performs the symbol order reversion and the phase shift (phase changing) on the second precoded symbol. Furthermore, different GIs are inserted in the first precoded symbol and the second precoded symbol.

This makes it possible to switch among a plurality of data modulation schemes in MIMO channels, and thus it is possible to achieve a great frequency diversity effect. It is also possible to reduce the communication data error rate and improve the data throughput.

### Modifications of Third Embodiment

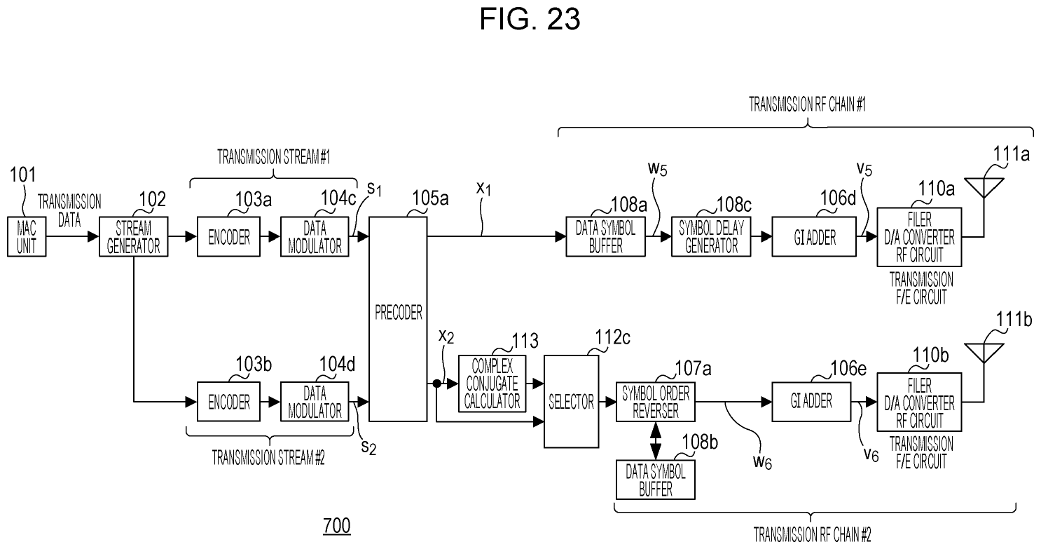

In the third embodiment described above, the transmission apparatus 400 performs MIMO transmission in which the symbol order reverser 107a performs the symbol order reversion on the data symbols and on symbols of GI. In a modification of the third embodiment described below, a transmission apparatus 700 (see FIG. 23) performs MIMO transmission such that the GI adders 106d and 106e add series (for example, orthogonal series) which are different for each stream.

FIG. 23 is a diagram illustrating a configuration of a transmission apparatus 700 according to the modification of the third embodiment. Note that in FIG. 23, same constituent elements as those in FIG. 12 or 20 are denoted by similar reference numerals, and a description thereof is omitted.

A GI adder 106d is disposed at a stage following a symbol delay generator 108c following a data symbol buffer 108a, and a GI adder 106e is disposed at a stage following a symbol order reverser 107a following a selector 112c. Unlike the transmission apparatus 400 shown in FIG. 12, the transmission apparatus 700 may add a GI symbol determined for each stream regardless of the modulation scheme.

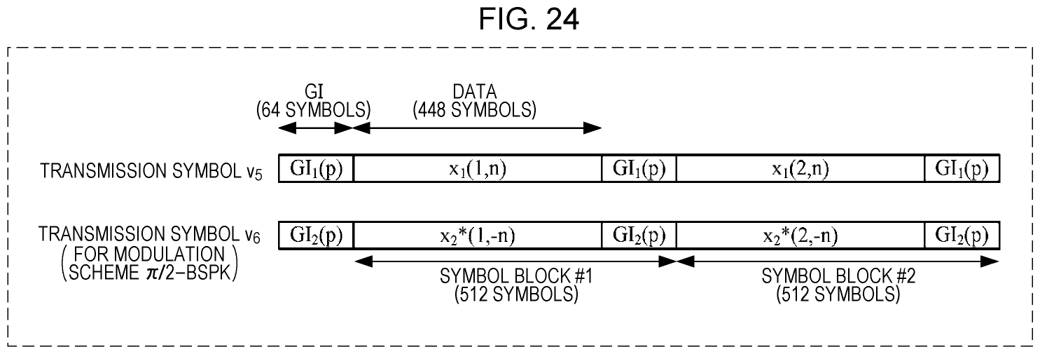

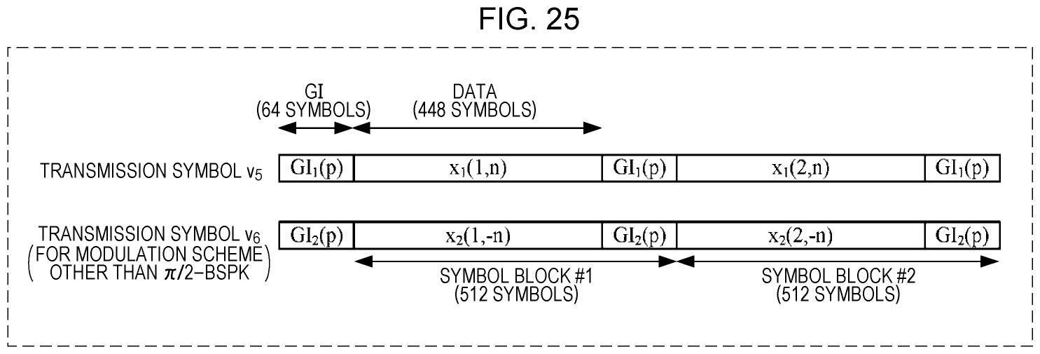

FIGS. 24 and 25 each illustrate an example of a transmission symbol format of outputs (v₅ and v₆) output from the GI adder 106d and 106e of the transmission apparatus 700. FIG. 24 illustrates a case where the data symbol is modulated by π/2-BPSK modulation. FIG. 25 illustrates a case where the data symbol is modulated by a modulation scheme other than π/2-BPSK modulation.

The GI adder 106d divides the precoded symbol x₁(m) into data blocks each including 448 symbols and adds 64-symbol GI(GI₁(p)) in front of each data block. GI is a symbol sequence obtained by performing π/2-BPSK modulation on a known series. Furthermore, the GI adder 106d adds a 64-symbol GI after a last data block. As a result, a transmission symbol v₅ such as that shown in FIG. 24 or 25 is generated. Note that the numbers of symbols employed above are merely examples, and the numbers of symbols in the present embodiment may be different from these examples.

Similarly, the GI adder 106e also divides the precoded symbol x₂(m) into data blocks each including 448 symbols and adds a 64-symbol GI (GI₂(p)) in front of each data block, and further adds 64-symbol GI after a last data block. As a result, a transmission symbol v₆ such as that shown in FIG. 24 or 25 is generated. GI added by the GI adder 106e may be different from a series of GI added by the GI adder 106d.

In a case where a transmission signal in the format shown in FIG. 24 and FIG. 25 is received from the transmission apparatus 700, the reception apparatus 200 may perform MMSE equalization according to equation (12-2) as in the third embodiment in the reception process.

The reception apparatus 200 may detect an error of the channel estimation matrix by comparing the MMSE-equalized GI symbol (part associated with GI in the output from the MMSE filter 207) with a known GI symbol, and may correct the channel estimation matrix. In a case where GI₁(p) and GI₂(p) are orthogonal series, a calculation is performed to determine a correlation between the GI₁(p) estimated by MMSE equalization and the known GI₁(p). As a result of this calculation, a residual error of MMSE equalization is reduced and, for example, a value of phase shift is calculated with high accuracy. Thus, it is possible to make a high-accuracy correction of a channel estimation matrix, which results in an improvement in reception performance.

In a case where the MMSE filter 207 of the reception apparatus 200 receives a transmission signal in the format shown in FIG. 24 and FIG. 25 from the transmission apparatus 700, MMSE equalization may be performed by subtracting GI symbol replica from the reception signal according to equation 39, equation 40, and equation 41 as in the modification of the second embodiment. This makes it possible to reduce an influence of GI on the MMSE equalization of data symbols, which results in an improvement in reception performance.

### Effects of Modifications of Third Embodiment

In the modification of the third embodiment described above, the transmission apparatus 700 performs the complex conjugate calculation process, depending on the precoding scheme type, on the precoded symbol x₂ and further performs the symbol order reversion process. As a result, the transmission apparatus 700 obtains a result equal to a result obtained by performing precoding depending on the frequency bin number k. Furthermore, different GIs are inserted in the first precoded symbol and the second precoded symbol.

Thus, it is possible to achieve a great frequency diversity effect in MIMO channel. It is also possible to reduce the communication data error rate and improve the data throughput.

### Modifications of Fourth Embodiment

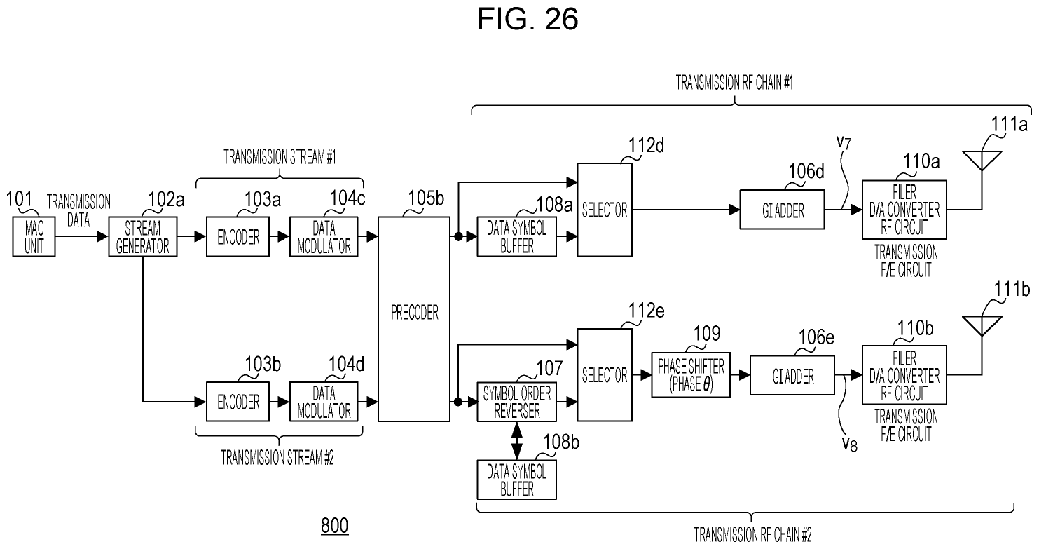

In the fourth embodiment described above, the transmission apparatus 500 haws a function of switching between one-stream transmission and two-stream transmission. In two-stream transmission, when the precoding matrix is of the first precoding scheme type, the symbol order reversion is performed in MIMO transmission. In a modification of the fourth embodiment described below, a transmission apparatus 800 (see FIG. 26) performs MIMO transmission such that the GI adders 106d and 106e add series (for example, orthogonal series) which are different for each stream.

FIG. 26 is a diagram illustrating a configuration of a transmission apparatus 800 according to the modification of the fourth embodiment. Note that in FIG. 26, same constituent elements as those in FIG. 17 are denoted by similar reference numerals, and a description thereof is omitted.

The GI adder 106d is disposed at a stage following the selector 112d, and the GI adder 106e is disposed at a stage following the phase shifter 109 following the selector 112e. Unlike the transmission apparatus 500 shown in FIG. 17, the transmission apparatus 800 may add a GI symbol determined for each stream regardless of the modulation scheme.

A transmission signal transmitted by the transmission apparatus 800 is a signal obtained by replacing GI of the transmission signal transmitted by the transmission apparatus 500 with GI output by the GI adder 106d or 106e. The receiving and demodulating method of the signals including GI output from the GI adders 106d and 106e has been described above as the operation of the reception apparatus 200 according to the modification of the second embodiment.

As with the modification of the second embodiment, the transmission apparatus 800 according to the modification of the fourth embodiment can achieve a diversity effect by performing symbol order reversion and phase shift also in the case where GI is replaced as in the case where GI is not replaced (according to the fourth embodiment).

Note that the transmission apparatus 900 according to the fourth embodiment is equivalent to a transmission apparatus obtained by modifying the transmission apparatus 600 shown in FIG. 20 such that switching is performed between the one-stream transmission and two-stream transmission. The transmission apparatus 900 according to the present embodiment is also equivalent to a transmission apparatus obtained by modifying the transmission apparatus 700 shown in FIG. 23 such that switching is performed between the one-stream transmission and two-stream transmission. In one-stream transmission, the precoding matrix is of the second precoding scheme type. In this case, the selector 112c in the transmission apparatus 700 selects the output from the complex conjugate calculator 113.

Note that in the one-stream transmission, transmission apparatus 700 performs the complex conjugate conversion process and the symbol order reversion process on the signal of the transmission RF chain #2. Thus, a phase shift effect according to equation (19) is obtained, which allows it to achieve a frequency diversity effect, and thus an improvement in communication performance is achieved.

### Effects of Modifications of Fourth Embodiment

In the modification of the fourth embodiment described above, the transmission apparatus 800 operates such that an operation mode is switched depending on whether two transmission streams are output or one transmission stream is output. In a case where a first precoded symbol and a second precoded symbol are complex conjugate to each other, the transmission apparatus 800 performs the symbol order reversion and the phase shift (phase changing) on the second precoded symbol. Furthermore, different GIs are inserted in the first precoded symbol and the second precoded symbol.

Thus, it is possible to achieve a great frequency diversity effect in MIMO channel. It is also possible to reduce the communication data error rate and improve the data throughput.

In the embodiments described above, each of the transmission apparatus 100 shown in FIG. 3, the transmission apparatus 300 shown in FIG. 9, the transmission apparatus 400 shown in FIG. 12, the transmission apparatus 500 shown in FIG. 17, the transmission apparatus 600 shown in FIG. 20, the transmission apparatus 700 shown in FIG. 23, and the transmission apparatus 800 shown in FIG. 26 is configured such that after transmission data is divided into streams by the stream generator 102 or 102a, each stream is encoded by the encoders 103a and 103b, and data modulation is performed by the data modulators 104a and 104b or the data modulator 104c and 104d on a stream-by-stream basis. However, the dividing into streams may be performed after the transmission data is encoded.

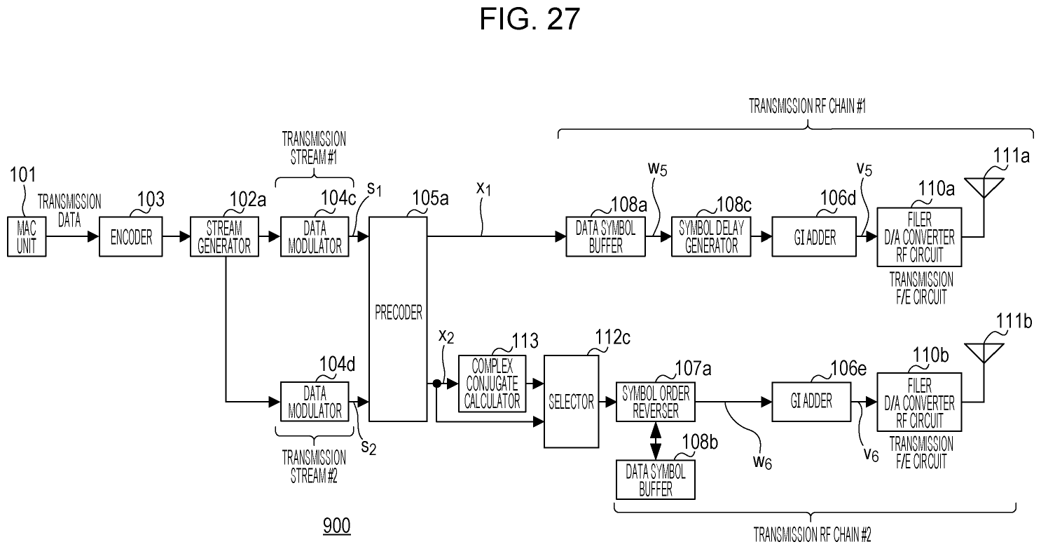

For example, as shown in FIG. 27, first, the encoder 103 may encode the transmission data, then stream generator 102a may generate streams from the encoded transmission data and output the resultant streams to the data modulators 104c and 104d. Also in this configuration shown in FIG. 27, it is possible to obtain effects similar to those achieved by the configurations shown in FIG. 3, FIG. 9, FIG. 12, FIG. 17, FIG. 20, FIG. 23, and FIG. 26.

### Other Embodiments

Each functional block according to any embodiment described above may be typically realized by an integrated circuit such as an LSI. Each of the functional blocks may be formed individually on one chip, or part or all of the functional blocks may be formed on one chip. The system LSI may also be referred to as an IC, an LSI circuit, a super LSI circuit, or an ultra LSI circuit depending on the degree of integration.

Furthermore, the technique of implementing the integrated circuit is not limited to the LSI, but the integrated circuit may be realized in the form of a dedicated circuit or a general-purpose processor. An FPGA (Field Programmable Gate Array) that can be programmed after the manufacture of the LSI or a reconfigurable processor in which the connections and the settings of circuit cells disposed inside the LSI can be reconfigured may be used.

When a new integration circuit technique other than LSI techniques are realized in the future by an advance in semiconductor technology or related technology, the functional blocks may be realized using such a new technique. A possible example of a new technique is biotechnology.

### Summary of the Present Disclosure

In an aspect of the present disclosure, a transmission apparatus includes a precoder that generates a first precoded signal and a second precoded signal by performing a precoding process on a first baseband signal and a second baseband signal, an order reverser that generates a reversed signal by reversing an order of a symbol sequence forming the second precoded signal, and a transmitter that transmits the first precoded signal and the reversed signal respectively from different antennas such that each signal is transmitted using a single-carrier.

The transmission apparatus may further include a delay generator that causes a delay to occur in either one of the first precoded signal generated by the precoder and the second reversed signal generated by the order reverser.

The transmission apparatus may further include a complex conjugate calculator that converts the second precoded signal generated by the precoder to a signal complex conjugate to the second precoded signal.

The transmission apparatus may further include an adder that adds a known signal to each of the first precoded signal and the second precoded signal.

The transmission apparatus may further include an encoder that performs a coding process on transmission data, a stream generator that generates first transmission data and second transmission data from the transmission data subjected to the coding process, and a modulator that generates the first baseband signal from the first transmission data and generates the second baseband signal from the second transmission data.

The transmission apparatus may further include a stream generator that generates first transmission data and second transmission data from transmission data, an encoder that performs a coding process on each of the first transmission data and the second transmission data, and a modulator that generates the first baseband signal from the first transmission data subjected to the coding process and generates the second baseband signal from the second transmission data subjected to the coding process.

In an aspect of the present disclosure, a transmission method includes generating a first precoded signal and a second precoded signal by performing a precoding process on a first baseband signal and a second baseband signal, generating a second reversed signal by reversing an order of a symbol sequence forming the second precoded signal, and transmitting the first precoded signal and the second reversed signal respectively from different antennas such that each signal is transmitted using a single-carrier.

In an aspect of the present disclosure, a reception apparatus includes a receiver that receives, via respective different antennas, a single-carrier first precoded signal subjected to a precoding process by a transmission apparatus and a single-carrier reversed signal subjected to the precoding process and further a symbol sequence order reversion process by the transmission apparatus, an order reverser that generates a second precoded signal by reversing an order of a symbol sequence forming the reversed signal, and an inverse precoder that performs an inverse precoding process on the first precoded signal and the second precoded signal thereby generating a first baseband signal and a second baseband signal.

In an aspect of the present disclosure, a reception method includes receiving, via respective different antennas, a single-carrier first precoded signal subjected to a precoding process by a transmission apparatus and a single-carrier reversed signal subjected to the precoding process and further a symbol sequence order reversion process by the transmission apparatus, generating a second precoded signal by reversing an order of a symbol sequence forming the reversed signal, and performing an inverse precoding process on the first precoded signal and the second precoded signal thereby generating a first baseband signal and a second baseband signal.

The present disclosure is suitable for use in a transmission apparatus, a transmission method, a reception apparatus, and a reception method, for communication using a multi-antenna.

What is claimed is:

1. A transmission apparatus comprising:
a precoder that generates a first precoded signal and a second precoded signal by performing a precoding process on a first baseband signal and a second baseband signal;
an order reverser that generates a reversed signal by reversing an order of a symbol sequence forming the second precoded signal; and
a transmitter that transmits the first precoded signal and the reversed signal respectively from different antennas such that each signal is transmitted using a single-carrier.

2. The transmission apparatus according to claim 1, further comprising a delay generator that delays either one of the first precoded signal generated by the precoder and the second reversed signal generated by the order reverser.

3. The transmission apparatus according to claim 1, further comprising a complex conjugate calculator that converts the second precoded signal generated by the precoder to a signal complex conjugate.

4. The transmission apparatus according to claim 1, further comprising an adder that adds a known signal to each of the first precoded signal and the second precoded signal.

5. The transmission apparatus according to claim 1, further comprising
an encoder that performs a coding process on transmission data,
a stream generator that generates first transmission data and second transmission data from the transmission data subjected to the coding process, and
a modulator that generates the first baseband signal from the first transmission data and generates the second baseband signal from the second transmission data.

6. The transmission apparatus according to claim 1, further comprising
a stream generator that generates first transmission data and second transmission data from transmission data,
an encoder that performs a coding process on each of the first transmission data and the second transmission data, and
a modulator that generates the first baseband signal from the first transmission data subjected to the coding process and generates the second baseband signal from the second transmission data subjected to the coding process.

7. A transmission method comprising:
generating a first precoded signal and a second precoded signal by performing a precoding process on a first baseband signal and a second baseband signal;
generating a second reversed signal by reversing an order of a symbol sequence forming the second precoded signal; and
transmitting the first precoded signal and the second reversed signal respectively from different antennas such that each signal is transmitted using a single-carrier.

8. A reception apparatus comprising:
a receiver that receives, via respective different antennas, a single-carrier first precoded signal subjected to a precoding process by a transmission apparatus and a single-carrier reversed signal subjected to the precoding process and further a symbol sequence order reversion process by the transmission apparatus;
an order reverser that generates a second precoded signal by reversing an order of a symbol sequence forming the reversed signal; and
an inverse precoder that performs an inverse precoding process on the first precoded signal and the second precoded signal thereby generating a first baseband signal and a second baseband signal.

9. A reception method comprising:
receiving, via respective different antennas, a single-carrier first precoded signal subjected to a precoding process by a transmission apparatus and a single-carrier reversed signal subjected to the precoding process and further a symbol sequence order reversion process by the transmission apparatus;
generating a second precoded signal by reversing an order of a symbol sequence forming the reversed signal; and
performing an inverse precoding process on the first precoded signal and the second precoded signal thereby generating a first baseband signal and a second baseband signal.
